(19) United States
(12) Patent Application Publication
(10) Pub. No.: US 2025/0328049 A1
(43) Pub. Date: Oct. 23, 2025

(54) DISPLAY DEVICE

(71) Applicant: InnoLux Corporation, Miao-Li County (TW)

(72) Inventors: Cheng-Yu YANG, Miao-Li County (TW); Ming-Jou TAI, Miao-Li County (TW); Chih-Hao CHANG, Miao-Li County (TW); Chia-Hao TSAI, Miao-Li County (TW)

(73) Assignee: InnoLux Corporation, Miao-Li County (TW)

(21) Appl. No.: 19/088,979

(22) Filed: Mar. 24, 2025

(30) Foreign Application Priority Data
Apr. 23, 2024 (CN) 202410488083.7

(51) Int. Cl. G02F 1/1362; G02F 1/1339

(52) U.S. Cl. CPC G02F 1/136286; G02F 1/13392; G02F 1/136209

(57) ABSTRACT

ABSTRACT OF DISCLOSURE

A display device includes a substrate, scan lines disposed on the substrate and extending along a first direction, data lines disposed on the substrate and extending along a second direction, and spacers. The scan lines and the data lines cross each other at crossing positions and form sub-pixel regions, and one of the sub-pixel regions has a sub-pixel width. The spacers are disposed on the crossing positions and arranged in a plurality of rows in the second direction. The spacers include a plurality of n^{th} row spacers and a plurality of n+1^{th} row spacers arranged along the first direction. The n^{th} row spacers and the n+1^{th} row spacers are staggered in the second direction. A first pitch is included between adjacent two of the spacers in one of the rows in the first direction, and the first pitch is 2-12 times the sub-pixel width.

### BACKGROUND OF THE DISCLOSURE

### 1. Field of the Disclosure

The present disclosure relates to a display device, and more particularly to a display device including photo spacers.

### 2. Description of the Prior Art

Current display devices (such as liquid crystal display devices) may include spacers to maintain the thickness of the structure between the substrates. However, as the demands for resolution of display devices increase, the spacers may cause difference in aperture ratios between pixels, thereby affecting the display quality of the display device. Therefore, to reduce the influence of the spacers on the display quality of the display device is still an important issue in the present field.

### SUMMARY OF THE DISCLOSURE

The present disclosure aims at providing a display device including spacers.

In some embodiments, a display device is provided by the present disclosure. The display device includes a substrate, a plurality of scan lines disposed on the substrate and extending along a first direction respectively, a plurality of data lines disposed on the substrate and extending along a second direction respectively, and a plurality of spacers. The plurality of scan lines and the plurality of data lines cross each other at a plurality of crossing positions and form a plurality of sub-pixel regions, and one of the plurality of sub-pixel regions has a sub-pixel width. The plurality of spacers are disposed on a portion of the crossing positions and arranged in a plurality of rows in the second direction. The spacers include a plurality of n^{th} row spacers and a plurality of n+1^{th} row spacers arranged along the first direction, wherein the plurality of n^{th} row spacers and the plurality of n+1^{th} row spacers are staggered in the second direction. A first pitch is included between adjacent two of the spacers in one of the plurality of rows in the first direction, and the first pitch is 2-12 times the sub-pixel width.

In some embodiments, a display device is provided by the present disclosure. The display device includes a substrate, a plurality of scan lines disposed on the substrate and extending along a first direction respectively, a plurality of data lines disposed on the substrate and extending along a second direction respectively, and a plurality of spacers. The plurality of scan lines and the plurality of data lines cross each other at a plurality of crossing positions. The plurality of spacers are disposed on the plurality of crossing positions and arranged in a plurality of rows in the second direction. The plurality of spacers include a first spacer located in a n^{th} row of the plurality of rows, a second spacer adjacent to the first spacer and located in a n−1^{th} row of the plurality of rows, a third spacer adjacent to the first spacer and located in a n+1^{th} row of the plurality of rows and a fourth spacer adjacent to the third spacer and located in a n+2^{th} row of the plurality of rows, wherein the first spacer, the second spacer and the third spacer are staggered in the second direction, and the first spacer, the third spacer and the fourth spacer are staggered in the second direction. A first distance is included between the first spacer and the second spacer in the first direction, a second distance is included between the first spacer and the third spacer in the first direction, and a third distance is included between the third spacer and the fourth spacer in the first direction, wherein the first distance, the second distance and the third distance are different from each other.

In some embodiments, a display device is provided by the present disclosure. The display device includes a substrate, a plurality of scan lines disposed on the substrate and extending along a first direction respectively, a plurality of data lines disposed on the substrate and extending along a second direction respectively, and a plurality of spacers. The plurality of scan lines and the plurality of data lines cross each other at a plurality of crossing positions. The plurality of spacers are disposed on the plurality of crossing positions and arranged in a plurality of rows in the second direction. The plurality of spacers include a first spacer located in a n^{th} row of the plurality of rows, a second spacer adjacent to the first spacer and located in a n−2^{th} row of the plurality of rows, a third spacer adjacent to the first spacer and located in a n+2^{th} row of the plurality of rows and a fourth spacer adjacent to the third spacer and located in a n+4^{th} row of the plurality of rows, wherein the first spacer, the second spacer and the third spacer are staggered in the second direction, and the first spacer, the third spacer and the fourth spacer are staggered in the second direction. A first distance is included between the first spacer and the second spacer in the first direction, a second distance is included between the first spacer and the third spacer in the first direction, and a third distance is included between the third spacer and the fourth spacer in the first direction, wherein the first distance, the second distance and the third distance are different from each other.

These and other objectives of the present disclosure will no doubt become obvious to those of ordinary skill in the art after reading the following detailed description of the embodiment that is illustrated in the various figures and drawings.

### BRIEF DESCRIPTION OF THE DRAWINGS

FIG. 1 schematically illustrates a partial top view of a display device according to a first embodiment of the present disclosure.

FIG. 2 schematically illustrates a partial top view of a display device according to a second embodiment of the present disclosure.

FIG. 3 schematically illustrates a partial top view of a display device according to a variant embodiment of the second embodiment of the present disclosure.

FIG. 4 schematically illustrates a partial top view of a display device according to another variant embodiment of the second embodiment of the present disclosure.

FIG. 5 schematically illustrates a partial top view of a display device according to yet another variant embodiment of the second embodiment of the present disclosure.

FIG. 6 schematically illustrates a partial top view of a display device according to a third embodiment of the present disclosure.

FIG. 7 schematically illustrates a partial top view of a display device according to a fourth embodiment of the present disclosure.

FIG. 8 schematically illustrates a partial top view of a display device according to a fifth embodiment of the present disclosure.

FIG. 9 schematically illustrates a partial cross-sectional view of the display device according to the fifth embodiment of the present disclosure.

FIG. 10 schematically illustrates a partial top view of a display device according to a variant embodiment of the fifth embodiment of the present disclosure.

FIG. 11 schematically illustrates a partial top view of a display device according to a sixth embodiment of the present disclosure.

FIG. 12 schematically illustrates a partial top view of a display device according to a seventh embodiment of the present disclosure.

### DETAILED DESCRIPTION

The present disclosure may be understood by reference to the following detailed description, taken in conjunction with the drawings as described below. It is noted that, for purposes of illustrative clarity and being easily understood by the readers, various drawings of this disclosure show a portion of the device, and certain elements in various drawings may not be drawn to scale. In addition, the number and dimension of each element shown in drawings are only illustrative and are not intended to limit the scope of the present disclosure.

Certain terms are used throughout the description and following claims to refer to particular elements. As one skilled in the art will understand, electronic equipment manufacturers may refer to an element by different names. This document does not intend to distinguish between elements that differ in name but not function.

In the following description and in the claims, the terms “include”, “comprise” and “have” are used in an open-ended fashion, and thus should be interpreted to mean “include, but not limited to . . . ”.

It will be understood that when an element or layer is referred to as being “disposed on” or “connected to” another element or layer, it can be directly on or directly connected to the other element or layer, or intervening elements or layers may be presented (indirectly). In contrast, when an element is referred to as being “directly on” or “directly connected to” another element or layer, there are no intervening elements or layers presented. When an element or a layer is referred to as being “electrically connected” to another element or layer, it can be a direct electrical connection or an indirect electrical connection. The electrical connection or coupling described in the present disclosure may refer to a direct connection or an indirect connection. In the case of a direct connection, the ends of the elements on two circuits are directly connected or connected to each other by a conductor segment. In the case of an indirect connection, switches, diodes, capacitors, inductors, resistors, other suitable elements or combinations of the above elements may be included between the ends of the elements on two circuits, but not limited thereto.

Although terms such as first, second, third, etc., may be used to describe diverse constituent elements, such constituent elements are not limited by the terms. The terms are used only to discriminate a constituent element from other constituent elements in the specification. The claims may not use the same terms, but instead may use the terms first, second, third, etc. with respect to the order in which an element is claimed. Accordingly, in the following description, a first constituent element may be a second constituent element in a claim.

According to the present disclosure, the thickness, length and width may be measured through optical microscope, and the thickness or width may be measured through the cross-sectional view in the electron microscope, but not limited thereto.

In addition, any two values or directions used for comparison may have certain errors. In addition, the terms “equal to”, “equal”, “the same”, “approximately” or “substantially” are generally interpreted as being within ±10%, ±5%, ±3%, ±2%, ±1%, or ÷0.5% of the given value.

In addition, the terms “the given range is from a first value to a second value” or “the given range is located between a first value and a second value” represents that the given range includes the first value, the second value and other values there between.

If a first direction is said to be perpendicular to a second direction, the included angle between the first direction and the second direction may be located between 80 to 100 degrees. If a first direction is said to be parallel to a second direction, the included angle between the first direction and the second direction may be located between 0 to 10 degrees.

Unless it is additionally defined, all terms (including technical and scientific terms) used herein have the same meaning as commonly understood by those ordinary skilled in the art. It can be understood that these terms that are defined in commonly used dictionaries should be interpreted as having meanings consistent with the relevant art and the background or content of the present disclosure, and should not be interpreted in an idealized or overly formal manner, unless it is specifically defined in the embodiments of the present disclosure.

It should be noted that the technical features in different embodiments described in the following can be replaced, recombined, or mixed with one another to constitute another embodiment without departing from the spirit of the present disclosure.

The electronic device of the present disclosure may include a display device, a sensing device, a back-light device, an antenna device, a tiled device or other suitable electronic devices, but not limited thereto. The electronic device of the present disclosure may be a foldable electronic device, a flexible electronic device or a stretchable electronic device. The display device may include a non-self-emissive display device or a self-emissive display device. The non-self-emissive display device for example includes a liquid crystal display device, but not limited thereto. The self-emissive display device for example includes a light emitting diode display device, but not limited thereto. The display device may for example be applied to laptops, common displays, tiled displays, vehicle displays, touch displays, televisions, monitors, smart phones, tablets, light source modules, lighting devices or electronic devices applied to the products mentioned above, but not limited thereto. The sensing device may include a biosensor, a touch sensor, a fingerprint sensor, other suitable sensors or combinations of the above-mentioned sensors. The antenna device may for example include a liquid crystal antenna device, but not limited thereto. The tiled device may for example include a tiled display device or a tiled antenna device, but not limited thereto. The outline of the electronic device may be a rectangle, a circle, a polygon, a shape with curved edge or other suitable shapes. The electronic device may include electronic units, wherein the electronic units may include passive elements or active elements, such as capacitor, resistor, inductor, diode, transistor, sensors, and the like. The diode may include a light emitting diode or a photo diode. The light emitting diode may for example include an organic light emitting diode (OLED) or an inorganic light emitting diode. The inorganic light emitting diode may for example include a mini light emitting diode (mini LED), a micro light emitting diode (micro LED) or a quantum dot light emitting diode (QLED), but not limited thereto. The electronic device may include peripheral systems such as driving systems, controlling systems, light source systems to support display devices, antenna devices, wearable devices (such as augmented reality devices or virtual reality devices), vehicle devices (such as windshield of car) or tiled devices. The display device is taken as an example of the electronic device for describing the contents of the present disclosure in the following, but the present disclosure is not limited thereto. The electronic device of the present disclosure may be combinations of the above-mentioned devices, such as the combination of display device and other devices, but not limited thereto.

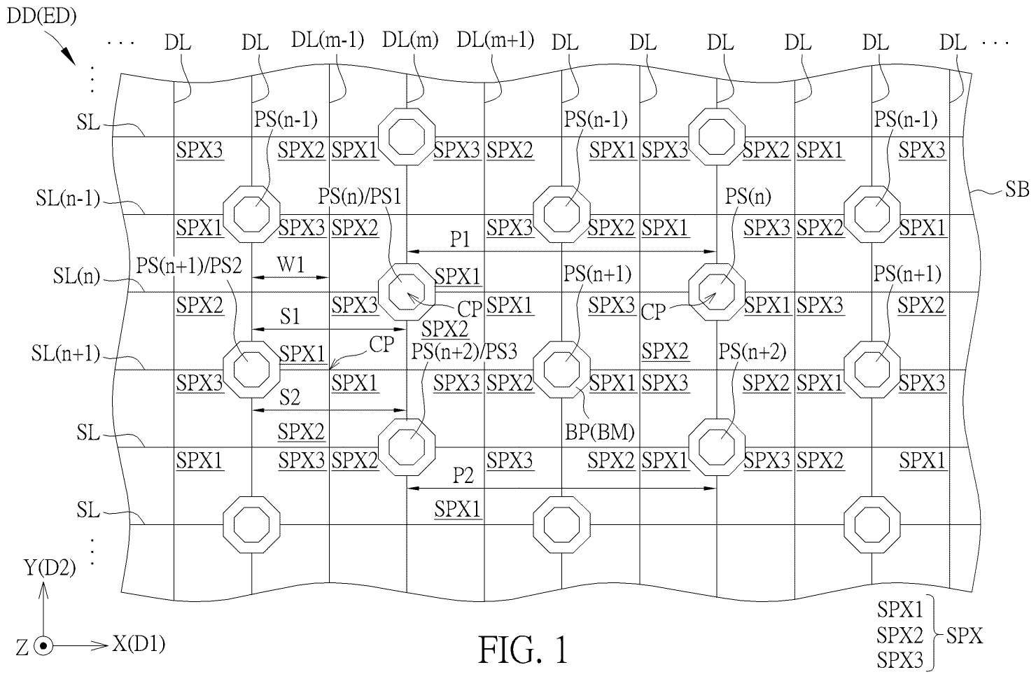

Referring to FIG. 1, FIG. 1 schematically illustrates a partial top view of a display device according to a first embodiment of the present disclosure. The electronic device ED shown in FIG. 1 may include a display device DD for displaying any suitable image, but not limited thereto. In other embodiments, the electronic device ED may further include other suitable devices or combinations of the display device DD and other devices. According to the present embodiment, the display device DD includes a substrate SB and a plurality of scan lines SL and a plurality of data lines DL disposed on the substrate SB. The substrate SB may be used for supporting the elements and the layers disposed thereon. The substrate SB may include a rigid material or a flexible material. The rigid material for example includes glass, quartz, sapphire, ceramic, other suitable materials or combinations of the above-mentioned materials.

The flexible material for example includes polyimide (PI), polycarbonate (PC), polyethylene terephthalate (PET), other suitable materials or combinations of the above-mentioned materials. The scan lines SL may extend along a first direction D1, and the data lines DL may extend along a second direction D2 not parallel to the first direction D1 and cross the scan lines SL. For example, the first direction D1 may be the direction X, and the second direction D2 may be the direction Y, wherein the first direction D1 may be perpendicular to the second direction D2, but not limited thereto. The scan lines SL and the data lines DL may include any suitable conductive material, such as metal materials, but not limited thereto. It should be noted that FIG. 1 just exemplarily shows the substrate SB and the scan lines SL and the data lines DL disposed on the substrate SB, and the detailed structure of the display device DD is not shown.

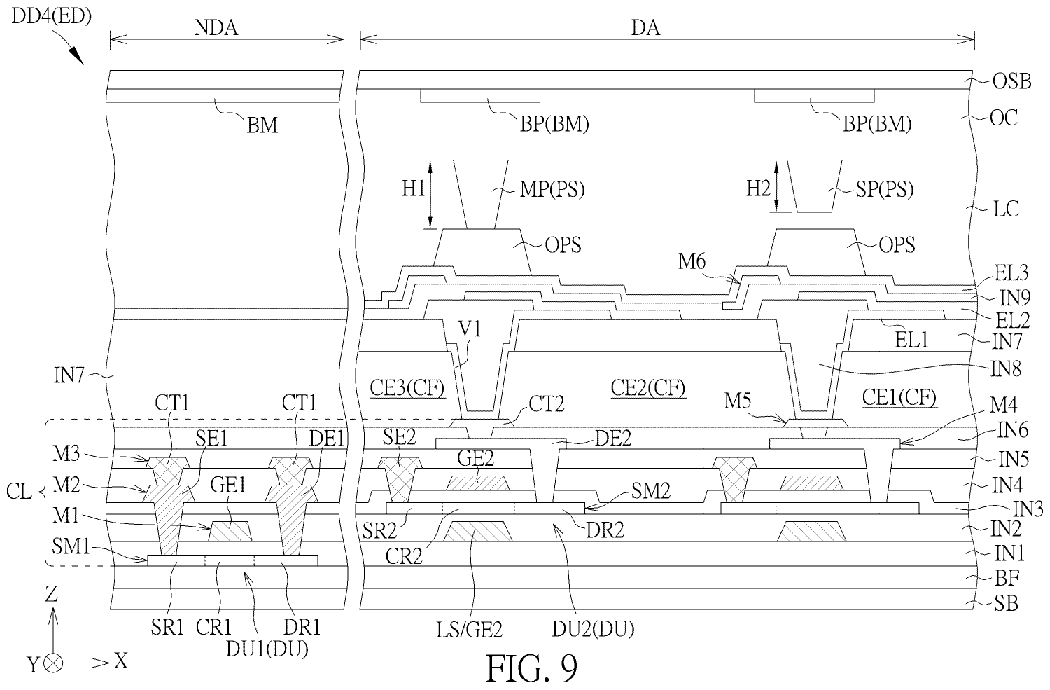

The structure of the display device DD may for example refer to the structure of the display device DD4 shown in FIG. 9, but not limited thereto. Specifically, the display device DD4 may include the substrate SB mentioned above and a circuit structure CL disposed on the substrate SB. The circuit structure CL may include various kinds of wires, circuits or electronic units that can be applied to the display device DD4. The circuit structure CL may include any suitable structure formed by stacking conductive layer(s) and insulating layer(s), wherein the conductive layer(s) may be used for forming the wires, the circuits or the electronic units mentioned above. As shown in FIG. 9, the circuit structure CL may include a semiconductor layer SM1 disposed on the substrate SB, an insulating layer IN1 disposed on the semiconductor layer SM1, a conductive layer M1 disposed on the insulating layer IN1, an insulating layer IN2 disposed on the conductive layer M1, a semiconductor layer SM2 disposed on the insulating layer IN2, an insulating layer IN3 disposed on the semiconductor layer SM2, a conductive layer M2 disposed on the insulating layer IN3, an insulating layer IN4 disposed on the conductive layer M2, a conductive layer M3 disposed on the insulating layer IN4, an insulating layer IN5 disposed on the conductive layer M3, a conductive layer M4 disposed on the insulating layer IN5, an insulating layer IN6 disposed on the conductive layer M4, and a conductive layer M5 disposed on the insulating layer IN6, but not limited thereto. In other embodiments, the circuit structure CL may include other suitable structures according to the design of the display device DD4.

As shown in FIG. 9, the circuit structure CL may include driving units DU. The circuit structure CL may further include other suitable electronic elements such as switch elements, and the scan lines SL and the data lines DL shown in FIG. 1 may be electrically connected to the switch elements, but not limited thereto. The driving unit DU for example includes a thin film transistor (TFT) element, but not limited thereto. Specifically, the driving units DU may include a first driving unit DU1 disposed in a non-display area NDA of the display device DD4 and a second driving unit DU2 disposed in a display area DA of the display device DD4. The display area DA may be the area of the display device DD4 mainly display images or capable of being operated by the user, and the display area DA may include a plurality of sub-pixel regions SPX (shown in FIG. 1). In some embodiments, the display area DA of the display device DD4 may for example be defined as the area enclosed by two of the scan lines SL (the scan lines SL shown in FIG. 1) respectively located at two ends of the scan lines SL and two of the data lines DL (the data lines DL shown in FIG. 1) respectively located at two ends of the data lines DL, but not limited thereto. In some embodiments, the display area DA may for example be defined as the area enclosed by the outer edges of the outermost sub-pixel regions SPX. The non-display area NDA may be defined as other area of the display device DD4 except the display area DA.

In detail, the first driving unit DU1 may include a semiconductor layer SM1, a gate electrode GE1, a source electrode SE1 and a drain electrode DE1. The semiconductor layer SM1 may include a source region SR1, a drain region DR1 and a channel region CR1 located between the source region SR1 and the drain region DR1. The source electrode SE1 is electrically connected to the source region SR1, and the drain electrode DE1 is electrically connected to the drain region DR1. The channel region CR1 may be disposed substantially corresponding to the gate electrode GE1. The gate electrode GE1 may be formed of the conductive layer M1, and the source electrode SE1 and the drain electrode DE1 may be formed of the conductive layer M2. The insulating layer IN1 may serve as the gate insulating layer of the first driving unit DU1. The semiconductor layer SM1 may include low temperature polycrystalline silicon (LTPS), but not limited thereto. The conductive layer M1 and the conductive layer M2 may include any suitable conductive material, such as metal materials, but not limited thereto. In some embodiments, the circuit structure CL may further include a contact element CT1, wherein the contact element CT1 may be electrically connected to the first driving unit DU1. The contact element CT1 may for example be formed of the conductive layer M3, wherein the contact element CT1 may penetrate the insulating layer IN4 and contact the source electrode SE1 and the drain electrode DE1 of the first driving unit DU1, thereby being electrically connected to the first driving unit DU1. The conductive layer M3 may include any suitable conductive material, such as metal materials, but not limited thereto. Although it is not shown in FIG. 9, the first driving unit DU1 may be electrically connected to external electronic elements through the contact element CT1, but not limited thereto.

The second driving unit DU2 may include a semiconductor layer SM2, a gate electrode GE2, a source electrode SE2 and a drain electrode DE2. The semiconductor layer SM2 may include a source region SR2, a drain region DR2 and a channel region CR2 located between the source region SR2 and the drain region DR2. The source electrode SE2 is electrically connected to the source region SR2, and the drain electrode DE2 is electrically connected to the drain region DR2. The channel region CR2 may be disposed substantially corresponding to the gate electrode GE2. The gate electrode GE2 may be formed of the conductive layer M2, the source electrode SE2 may be formed of the conductive layer M3, and the drain electrode DE2 may be formed of the conductive layer M4. The conductive layer M4 may include any suitable conductive material, such as transparent conductive materials, but not limited thereto. The insulating layer IN3 may serve as the gate insulating layer of the second driving unit DU2. The semiconductor layer SM2 may include metal oxides, such as indium gallium zinc oxide (IGZO), but not limited thereto. In some embodiments, the display device DD4 may further include a contact element CT2 electrically connected to the drain electrode DE2, wherein the contact element CT2 may be formed of the conductive layer M5. In some embodiments, the display device DD may further include a light shielding layer LS formed of the conductive layer M1, wherein the light shielding layer LS may be disposed corresponding to the semiconductor layer SM2 (or at least corresponding to the channel region CR2 of the semiconductor layer SM2). In some embodiments, the light shielding layer LS may serve as another gate electrode GE2 of the second driving unit DU2, that is, the second driving unit DU2 may include a dual gate thin film transistor element in this case.

It should be noted that the circuit structure CL shown in FIG. 9 is exemplary. In addition, in some embodiments, the display device DD4 may further include a buffer layer BF disposed between the substrate SB and the circuit structure CL, but not limited thereto. The insulating layers of the circuit structure CL shown in FIG. 9 may include any suitable organic insulating material or inorganic insulating material, based on the demands of design of the display device DD4.

As shown in FIG. 9, the display device DD4 may further include a light converting layer CF disposed on the circuit structure CL. The light converting layer CF may be directly disposed on the circuit structure CL, but not limited thereto. That is, the manufacturing method of the display device DD4 may include a color filter on array (COA) process. The light converting layer CF may be disposed in the display area DA, but not disposed in the non-display area NDA. The light converting layer CF may include any suitable element or layer that can change the wavelength or color of light passing through the light converting layer CF, such as color filter, but not limited thereto. In the present embodiment, the light converting layer CF may include a plurality of light converting elements, wherein the light converting elements may respectively allow light of different wavelengths or colors to pass through. For example, the light converting layer CF may include a first light converting element CE1, a second light converting element CE2 and a third light converting element CE3, wherein these light converting elements may respectively allow green light, red light and blue light to pass through, which can be mixed into a white light, but not limited thereto. In some embodiments, the display device DD4 may further include an insulating layer IN7 disposed on the light converting layer CF, wherein the portion of the insulating layer IN7 in the display area DA may contact the light converting layer CF, and the portion of the insulating layer IN7 in the non-display area NDA may contact the circuit structure CL, or contact the insulating layer IN6 of the circuit structure CL, but not limited thereto. The insulating layer IN7 may serve as a planarization layer to facilitate the disposition of other elements or layers thereon.

According to the present embodiment, as shown in FIG. 9, the display device DD4 may further include an electrode EL1, an insulating layer IN8 disposed on the electrode EL1, an electrode EL2 disposed on the insulating layer IN8, an insulating layer IN9 disposed on the electrode EL2, a conductive layer M6 disposed on the insulating layer IN9 and an electrode EL3 disposed on the conductive layer M6. The electrode EL1 may be filled into a via V1 and contact the contact element CT2, thereby being electrically connected to the second driving unit DU2 (or the drain electrode DE2 of the second driving unit DU2) through the contact element CT2. The via V1 may be formed by removing portions of the light converting layer CF and the insulating layer IN7. The insulating layer IN8 may be filled into the via V1 and cover the electrode EL1. The insulating layer IN8 may serve as the planarization layer to facilitate the disposition of other layers (such as the electrode EL2) thereon. The electrode EL2 may contact the electrode EL1, thereby being electrically connected to the electrode EL1. The electrode EL1, the electrode EL2 and the electrode EL3 may include any suitable conductive material, such as transparent conductive materials, but not limited thereto. The electrode EL1, the electrode EL2 and the electrode EL3 may serve as pixel electrodes or common electrodes. The insulating layer IN7, the insulating layer IN8 and the insulating layer IN9 may include any suitable organic insulating material or inorganic insulating material. The conductive layer M6 may include any suitable conductive material, such as metal materials, but not limited thereto.

In addition, the display device DD4 may further include a display medium layer LC located between the substrate SB and the opposite substrate OSB. For example, the display medium layer LC may be disposed between the electrode EL3 and a protecting layer OC. The display medium layer LC for example includes liquid crystal material, but not limited thereto.

Back to FIG. 1, according to the present disclosure, the plurality of scan lines SL may cross the plurality of data lines DL, wherein a position where a scan line SL crosses a data line DL may be defined as a crossing position CP. That is, the plurality of scan lines SL may cross the plurality of data lines DL at the plurality of crossing positions CP. In the present disclosure, as shown in FIG. 1, the n^{th} scan line SL in the display device DD may be represented by the label “SL(n)”, and the m^{th} data line DL in the display device DD may be represented by the label “DL(m)”, wherein “n” and “m” may be any suitable positive integer. Similarly, the m−1th data line DL and the m+1th data line DL may respectively be represented by the label “DL(m−1)” and “DL(m+1)”, and the n−1^{th} scan line SL and the n+1^{th} scan line SL may respectively be represented by the label “SL(n−1)” and “SL (n+1)”. In the present disclosure, other data lines DL and scan lines SL may be represented in the same way, but the labels are not shown in FIG. 1. In addition, for convenience of explanation, in the present disclosure, the crossing position CP where the n^{th} scan line SL crosses the m^{th} data line DL may be represented by a label “CP(n,m)” to clearly indicate different crossing positions CP. For example, in FIG. 1, the crossing position CP where the n+1^{th} scan line SL(n+1) crosses the m−1th data line DL(m−1) may be called “CP(n+1,m−1)” in the present disclosure.

In the present disclosure, the scan lines SL and the data lines DL may cross each other to form a plurality of sub-pixel regions SPX. Specifically, each of the plurality of grids formed by crossing the scan lines SL and the data lines DL in FIG. 1 may be regarded as a sub-pixel region SPX, that is, the sub-pixel regions SPX may be arranged in a plurality of columns and a plurality of rows respectively along the first direction D1 and the second direction D2. A sub-pixel region SPX may for example correspond to a light converting element (that is, one of the first light converting element CE1, the second light converting element CE2 and the third light converting element CE3 shown in FIG. 9) and a portion of the circuit structure CL to which the light converting element corresponds, but not limited thereto. In such condition, the sub-pixel regions SPX may include first sub-pixel regions SPX1, second sub-pixel regions SPX2 and third sub-pixel regions SPX3, wherein the first sub-pixel regions SPX1, the second sub-pixel regions SPX2 and the third sub-pixel regions SPX3 may respectively emit green light, red light and blue light, which can be mixed into a white, but not limited thereto. In the present embodiment, the plurality of sub-pixel regions SPX may have a sub-pixel rendering (SPR) arrangement, but not limited thereto. For example, in the plurality of sub-pixel regions SPX shown in FIG. 1, the sub-pixel regions SPX in the top row may be repeated in sequence as the third sub-pixel region SPX3, the second sub-pixel region SPX2, and the first sub-pixel region SPX1, the sub-pixel regions SPX in the second row may be repeated in sequence as the first sub-pixel region SPX1, the third sub-pixel region SPX3, and the second sub-pixel region SPX2, and the sub-pixel regions SPX in the third row may be repeated in sequence as the second sub-pixel region SPX2, the first sub-pixel region SPX1, and the third sub-pixel region SPX3. The sub-pixel regions SPX in other rows may be arranged through the above-mentioned way repeatedly. It should be noted that the arrangement of the sub-pixel regions SPX mentioned above is exemplary, and the present embodiment is not limited thereto. In other embodiments, the sub-pixel regions SPX may be arranged in any suitable way. According to the present embodiment, a sub-pixel region SPX may have a sub-pixel width W1, wherein the sub-pixel width W1 is the width of the sub-pixel region SPX in the first direction D1. For example, the sub-pixel width W1 may be defined as the minimum distance between adjacent two of the data lines DL in the first direction D1, but not limited thereto.

According to the present disclosure, the display device DD may further include a plurality of spacers PS disposed on the substrate SB. The plurality of spacers PS may be disposed on a portion of the crossing positions CP, that is, the plurality of spacers PS may be disposed corresponding to the portion of the crossing positions CP. Specifically, a spacer PS may be disposed on a crossing position CP formed by crossing a scan line SL and a data line DL. According to the present embodiment, the plurality of spacers PS disposed on the crossing positions CP may form a plurality of rows arranged along the first direction D1, wherein these rows may be arranged in the second direction D2, or these rows may be arranged side by side in the second direction D2. The plurality of rows of the spacers PS may respectively correspond to one of the scan lines SL. That is, the spacers PS corresponding to the same scan line SL may be defined as the spacers PS in the same row. In the present disclosure, the spacers PS in the n^{th} row of the spacers PS may be called “n^{th} row spacers PS(n)”; similarly, the spacers PS in the n+1^{th} row of the spacers PS may be called “n+1^{th} row spacers PS(n+1)”, to facilitate the description of the spacers PS located in different rows. In the present embodiment, each of the scan lines SL may correspond to one row of the spacers PS, but not limited thereto. In such condition, the n^{th} row spacers PS(n) may be disposed corresponding to the n^{th} scan line SL(n); similarly, the n+1^{th} row spacers PS(n+1) may be disposed corresponding to the n+1^{th} scan line SL(n+1). In other embodiments, the spacers PS may be disposed not corresponding to a portion of the scan lines SL.

The disposition way of the spacers PS of the present embodiment will be detailed in the following.

According to the present embodiment, in each of the rows, the spacers PS may be repeatedly (or periodically) disposed on the crossing positions CP in a pitch along the first direction D1. In other words, the pitch between any two adjacent spacers PS in a row in the first direction D1 may be fixed. For example, as shown in FIG. 1, the n^{th} row spacers PS(n) in the n^{th} row may be repeatedly (or periodically) disposed on the crossing positions CP in a first pitch P1 along the first direction D1, and adjacent two of the n^{th} row spacers PS(n) may have the first pitch P1 in the first direction D1. The pitches of two adjacent spacers PS in different rows in the first direction D1 may be the same, that is, the first pitch P1 mentioned above, but not limited thereto. In other words, the first pitch P1 may be included between any two adjacent spacers PS in any row in the first direction D1. In some embodiments, the pitches of two adjacent spacers PS in different rows in the first direction D1 may be different. In the present embodiment, “the pitch of two adjacent spacers PS in a row in the first direction D1” may be defined as the distance between the crossing positions CP to which the two adjacent spacers PS respectively correspond in the first direction D1. For example, the first pitch P1 may be the distance between a crossing position CP(for example, the crossing position CP(n,m)) to which one of two adjacent n^{th} row spacers PS(n) corresponds and another crossing position CP (for example, the crossing position CP(n, m+4)) to which another one of two adjacent n^{th} row spacers PS(n) corresponds in the first direction D1. As shown in FIG. 1, in a top view direction (that is, parallel to the direction Z) of the display device DD, the spacer PS may for example have a polygonal shape (such as an octagonal shape), but the present disclosure is not limited thereto. In other embodiments, the shape of the spacer PS may be a rectangle, a circle, an oval or other suitable shapes in the top view direction of the display device DD.

According to the present embodiment, the first pitch P1 is 2 to 12 times the sub-pixel width W1 of the sub-pixel region SPX (that is, 2W1≤P1≤12W1). Specifically, the first pitch P1 may be N times the sub-pixel width W1, wherein N may be a positive integer from 2 to 12, that is, the first pitch P1 may be an integer multiple of the sub-pixel width W1. In short, in the plurality of rows of the spacers PS, the spacers PS in each of the rows may be repeatedly (or periodically) disposed on the crossing positions CP every N sub-pixel regions SPX, wherein N is a positive integer from 2 to 12. For example, as shown in FIG. 1, the first pitch P1 may be 4 times the sub-pixel width W1 (that is, P1=4W1), that is, two adjacent spacers PS in any row may be separated by 4 sub-pixel regions SPX, but not limited thereto. In such condition, taking the n^{th} row spacers PS(n) located in the n^{th} row as an example, one of the n^{th} row spacers PS(n) may be disposed corresponding to the crossing position CP(n, m), and another one of the n^{th} row spacers PS(n) that is adjacent to the one of the nth row spacers PS(n) may be disposed corresponding to the crossing position CP(n,m+4). Similarly, although it is not shown in FIG. 1, the display device DD may further include another n^{th} row spacers PS(n) disposed corresponding to the crossing position CP(n, m+8). In other embodiments, the first pitch P1 may be 2 times, 6 times, 8 times or any integer multiple from 2 to 12 times the sub-pixel width W1.

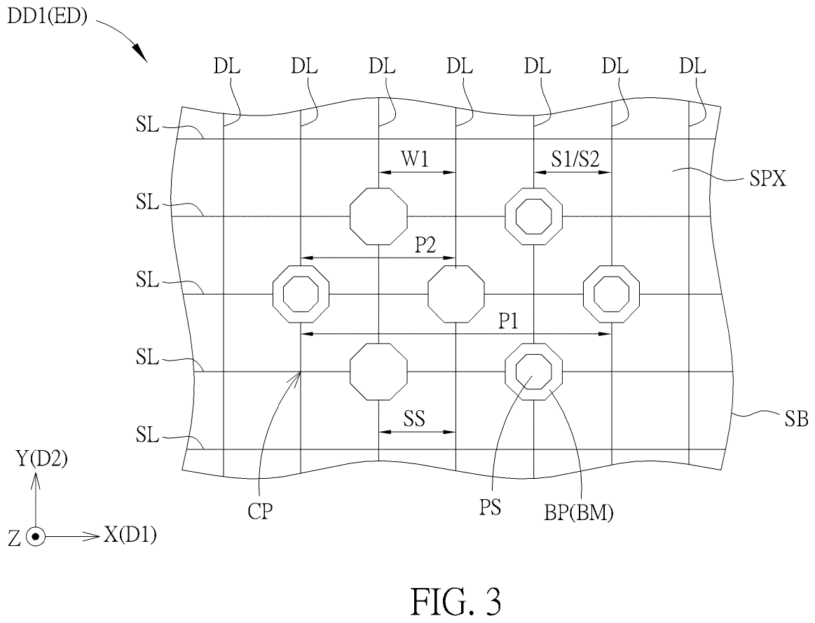

In addition, in the present embodiment, the spacers PS in a row and the spacers PS in another row adjacent to the row may be staggered in the second direction D2. Specifically, the spacers PS in a row are not corresponding to (or overlapped with) the spacers PS in another row adjacent to the row in the second direction D2. For example, as shown in FIG. 1, the spacers PS may include a plurality of n^{th} row spacers PS(n) and a plurality of n+1^{th} row spacers PS(n+1) arranged along the first direction D1, wherein the n^{th} row spacers PS(n) and the n+1^{th} row spacers PS(n+1) are staggered in the second direction D2, or the n^{th} row spacers PS(n) are not corresponding to (or overlapped with) the n+1^{th} row spacers PS (n+1) in the second direction D2. Similarly, the n+1^{th} row spacers PS (n+1) located in the n+1^{th} row and the n+2^{th} row spacers PS (n+2) located in the n+2^{th} row are staggered in the second direction D2. Therefore, the spacers PS in a row and the spacers PS in another row adjacent to the row may be arranged and extended in a zigzag pattern in the second direction D2. In such condition, the n^{th} row spacers PS(n) located in the nth row may include a first spacer PS1, and the n+1^{th} row spacers PS(n+1) located in the n+1^{th} row may include a second spacer PS2 adjacent to the first spacer PS1, wherein a first distance S1 is included between the first spacer PS1 and the second spacer PS2 in the first direction D1, and the first distance S1 is greater than 0. The first distance S1 may also be regarded as the offset distance between the spacers in two adjacent rows in the first direction D1. “The second spacer PS2 is adjacent to the first spacer PS1” mentioned above may represent that the second spacer PS2 is the one of the n+1^{th} row spacers PS(n+1) located in the n+1^{th} row with the smallest distance from the first spacer PS1. In other words, after the first spacer PS1 located in the n^{th} row is defined, a spacer PS with the smallest distance from the first spacer PS1 in the n+1^{th} row may be defined as the second spacer PS2. The first distance S1 may be an integer multiple of the sub-pixel width W1 and may be less than the first pitch P1. Specifically, the first distance S1 is greater than or equal to the sub-pixel width W1, and the first distance S1 may be less than or equal to half of the first pitch P1. In some embodiments, the first distance S1 may be half of the first pitch P1. For example, as shown in FIG. 1, the first pitch P1 may be 4 times the sub-pixel width W1, and the first distance S1 may be 2 times the sub-pixel width W1, but not limited thereto. In such condition, one of the spacers PS in a row (for example, one of the spacers PS in the n^{th} row in FIG. 1) may be disposed corresponding to the midpoint of two adjacent spacers PS in another row adjacent to the row (for example, two adjacent spacers PS in the n+1^{th} row in FIG. 1) in the second direction D2. In the condition mentioned above, the spacers PS are symmetrically disposed. That is, when the offset distance (that is, the first distance S1) of the spacers PS in two adjacent rows is half of the first pitch P1, the spacers PS may be symmetrically disposed. On the contrary, the spacers PS may be disposed asymmetrically. In the present disclosure, the definitions of “symmetrically disposed” or “asymmetrically disposed” of the spacers PS may refer to the contents mentioned above, and will not be redundantly described in the following. In some embodiments, the first pitch P1 may be 6 times the sub-pixel width W1, and the first distance S1 may be 3 times the sub-pixel width W1. In some embodiments, the first distance S1 may be less than half of the first pitch P1. For example, as shown in FIG. 3, the first pitch may be 4 times the sub-pixel width W1, and the first distance S1 may be the same as the sub-pixel width W1, but not limited thereto. In such condition, the spacers PS may be asymmetrically disposed.

In the present embodiment, as shown in FIG. 1, the spacers PS may further include a plurality of n+2^{th} row spacers PS(n+2) arranged along the first direction D1, wherein the n+2^{th} row spacers PS(n+2) and the n+1^{th} row spacers PS(n+1) are staggered in the second direction D2. In such condition, the n+2^{th} row spacers PS(n+2) may include a third spacer PS3 adjacent to the second spacer PS2 mentioned above, and a second distance S2 may be included between the second spacer PS2 and the third spacer PS3 in the first direction D1. According to the present embodiment, the second distance S2 may be the same as the first distance S1 mentioned above. For example, the first distance S1 and the second distance S2 in FIG. 1 are both 2 times the sub-pixel width W1, but not limited thereto. In other words, the offset distance (that is, the first distance S1) between the n^{th} row spacers PS(n) in the n^{th} row and the n+1^{th} row spacers PS(n+1) in the n+1^{th} row may be the same as the offset distance (that is, the second distance S2) between the n+1^{th} row spacers PS(n+1) in the n+1^{th} row and the n+2^{th} row spacers PS(n+2) in the n+2^{th} row. It should be noted that the above-mentioned feature may be applied to any row of the spacers PS. In other words, in the present embodiment, the offset distances of the spacers PS in any two adjacent rows may be the same. According to the design mentioned above, as shown in FIG. 1, the first spacer PS1 in the n^{th} row, the second spacer PS2 in the n+1^{th} row and the third spacer PS3 in the n+2^{th} row may extend in a zigzag pattern in the second direction D2.

FIG. 1 exemplarily shows the disposition positions of the spacers PS based on the above-mentioned design (for example, the design of the first pitch P1 and the design of the offset distance). Specifically, FIG. 1 shows the disposition of the spacers PS under the condition that the first pitch P1 is 4 times the sub-pixel width W1 and the offset distance is 2 times the sub-pixel width W1. In such condition, as shown in FIG. 1, the n^{th} row spacers PS(n) in the nth row may respectively be disposed corresponding to the crossing position CP(n,m), the crossing position CP(n,m+4), the crossing position CP(n,m+8) . . . ; the n+1^{th} row spacers PS(n+1) in the n+1^{th} row adjacent to the n^{th} row may respectively be disposed corresponding to the crossing position CP(n+1,m−2), the crossing position CP (n+1, m+2), the crossing position CP(n+1, m+6) . . . ; and the n+2^{th} row spacers PS(n+2) in the n+2^{th} row adjacent to the n+1^{th} row may respectively be disposed corresponding to the crossing position CP(n+2, m), the crossing position CP(n+2, m+4), the crossing position CP(n+2, m+8) . . . . In such condition, the n^{th} row spacers PS(n) may correspond to the n+2^{th} row spacers PS(n+2) in the second direction D2. Similarly, as shown in FIG. 1, the n−1^{th} row spacers PS(n−1) may correspond to the n+1^{th} row spacers PS(n+1) in the second direction D2. In other words, in the plurality of rows of the spacers PS, the spacers PS in every two rows may correspond to each other in the second direction D2. It should be noted that the disposition positions of the spacers PS shown in FIG. 1 are exemplary, and the present embodiment is not limited thereto.

The spacers PS disposed corresponding to the crossing positions CP may overlap a portion of the sub-pixel regions SPX in the top view direction of the display device DD. For example, as shown in FIG. 1, a spacer PS may overlap the four sub-pixel regions SPX surrounding the spacer PS in the top view direction of the display device DD. According to the present embodiment, through the above-mentioned design of the positions of the spacer PS, the difference in aperture ratios of different sub-pixel regions SPX (such as the first sub-pixel region SPX1, the second sub-pixel region SPX2 and the third sub-pixel region SPX3) may be reduced. For example, as shown in FIG. 1, each of the sub-pixel regions SPX may respectively overlap a portion of a spacer PS, and the proportion of the spacers PS in each of the sub-pixel regions SPX may be substantially the same. Therefore, the aperture ratios of the first sub-pixel region SPX1, the second sub-pixel region SPX2 and the third sub-pixel region SPX3 may be substantially the same, thereby reducing the possibility that the light emitting effect of the display device DD is affected due to excessive differences in the aperture ratios of different sub-pixel regions SPX. Therefore, the influence of the spacer PS on the display effect of the display device DD may be reduced.

According to the present disclosure, the display device DD may further include a light shielding layer BM disposed on the substrate SB. It should be noted that although it is not shown in FIG. 1, the light shielding layer BM may include portions corresponding to the plurality of scan lines SL and the plurality of data lines DL. That is, the light shielding layer BM overlaps the scan lines SL and the data lines DL in the normal direction (that is, the direction Z) or the top view direction of the display device DD. Specifically, the light shielding layer BM may include a grid structure and including a plurality of openings, wherein the plurality of sub-pixel regions SPX may be disposed corresponding to the openings of the grid structure of the light shielding layer BM. In order to simplify the figure, FIG. 1 does not show the portion of the light shielding layer BM overlapping the scan lines SL and the data lines DL. According to the present embodiment, the light shielding layer BM may include a plurality of light shielding patterns BP respectively correspond to the plurality of spacers PS disposed on the substrate SB. Specifically, in the normal direction of the display device DD, the plurality of light shielding patterns BP may overlap the plurality of spacers PS. In other words, the light shielding patterns BP may correspond to the crossing positions CP. In the top view direction of the display device DD, the size of the pattern of a light shielding pattern BP may be greater than or equal to the size of the pattern of the spacer PS to which the light shielding pattern BP corresponds to, such that the pattern of the spacer PS may be located within in the pattern of the light shielding pattern BP, but not limited thereto. “The size of the pattern of the light shielding pattern BP (or the spacer PS)” may be the area, the size of the pattern in a top view and/or the projection area on the substrate SB of the light shielding pattern BP (or the spacer PS). Since the light shielding patterns BP are disposed corresponding to the spacers PS in the present embodiment, the disposition positions of the light shielding patterns BP may be the same as the disposition positions of the spacers PS mentioned above. In other words, a second pitch P2 may be included between two adjacent light shielding patterns BP in a row in the first direction D1, wherein the second pitch P2 may be the same as the first pitch P1. The definition of the second pitch P2 may refer to the definition of the first pitch P1 mentioned above, for example, the second pitch P2 may be defined as the distance between the centers of two adjacent light shielding patterns BP in a row in the first direction D1, but not limited thereto. The light shielding layer BM may include any suitable light shielding material. For example, the light shielding layer BM may include a black matrix layer, but not limited thereto.

Other embodiments of the present disclosure will be described in the following. In order to simplify the description, the same elements or layers in the following embodiments would be labeled with the same symbol, and the features thereof will not be redundantly described. The differences between the embodiments will be detailed in the present disclosure.

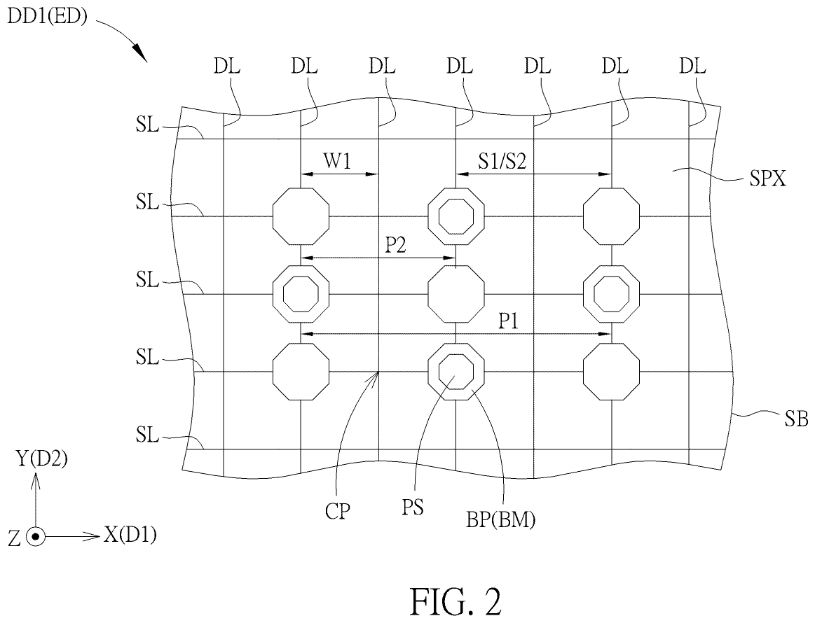

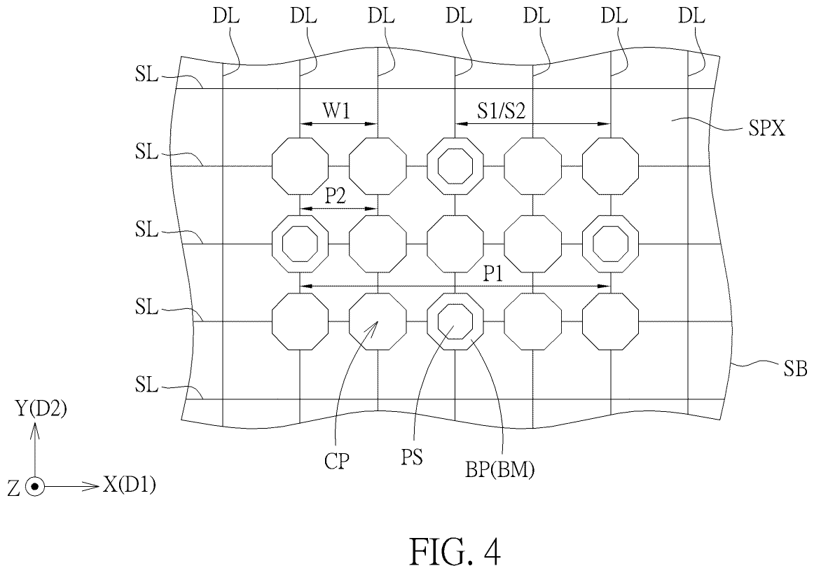

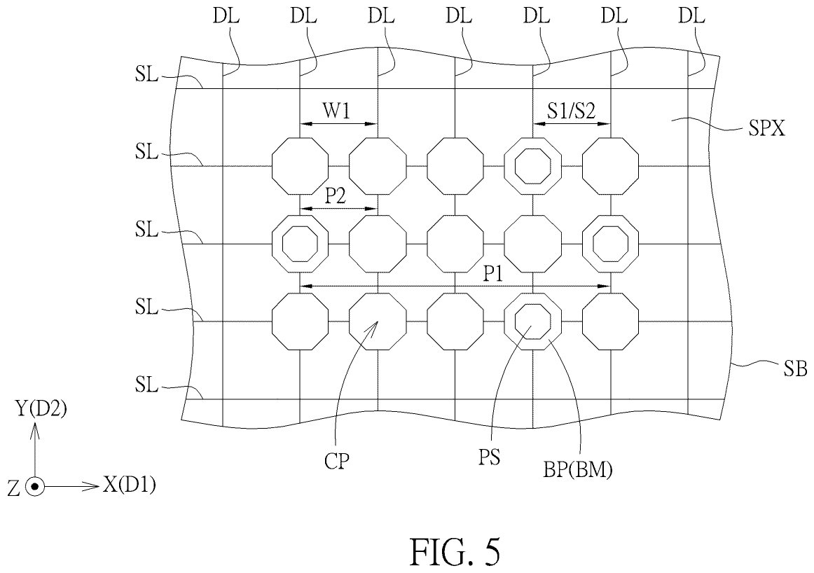

Referring to FIG. 2 to FIG. 5, FIG. 2 schematically illustrates a partial top view of a display device according to a second embodiment of the present disclosure, FIG. 3 schematically illustrates a partial top view of a display device according to a variant embodiment of the second embodiment of the present disclosure, FIG. 4 schematically illustrates a partial top view of a display device according to another variant embodiment of the second embodiment of the present disclosure, and FIG. 5 schematically illustrates a partial top view of a display device according to yet another variant embodiment of the second embodiment of the present disclosure. One of the main differences between the display device DD1 shown in FIG. 2 and the display device DD shown in FIG. 1 is the design of the light shielding patterns BP. Specifically, as shown in FIG. 2, the light shielding layer BM of the present embodiment may include a plurality of light shielding patterns BP disposed corresponding to the crossing positions CP where the scan lines SL and the data lines DL cross each other, wherein a portion of the light shielding patterns BP may correspond to the spacers PS, and another portion of the light shielding patterns BP may not correspond to the spacer PS. In other words, compared with the structure shown in FIG. 1, the light shielding layer BM of the display device DD1 of the present embodiment may include light shielding patterns BP that are not corresponding to the spacer PS, or the spacers PS may not correspond to all the light shielding patterns BP. Specifically, in the present embodiment, the plurality of light shielding patterns BP of the light shielding layer BM may be arranged in a plurality of rows along the first direction D1, wherein the light shielding patterns BP in each row may be repeatedly (or periodically) disposed on the crossing positions CP in a pitch in the first direction D1. In other words, the pitch between any two adjacent light shielding patterns BP in a row in the first direction D1 may be fixed. For example, as shown in FIG. 2, the light shielding patterns BP in a row may be repeatedly (or periodically) disposed on the crossing positions CP in a second pitch P2. The pitches of two adjacent light shielding patterns BP in different rows in the first direction D1 may be the same, that is, the second pitch P2. In other words, the light shielding patterns BP in each row may be repeatedly (or periodically) disposed on the crossing positions CP in the second pitch P2 in the first direction D1. The design of the positions of the spacers PS of the display device DD1 of the present embodiment may refer to the contents in the embodiment mentioned above, and will not be redundantly described. In other words, the first pitch P1 between two adjacent spacers PS may be greater than or equal to 2 times the sub-pixel width W1 in the present embodiment. In the present embodiment, the second pitch P2 between two adjacent light shielding patterns BP may be less than the first pitch P1 between two adjacent spacers PS. For example, the first pitch P1 may be an integer multiple of the second pitch P2, but not limited thereto. Therefore, the spacers PS disposed in the first pitch P1 may respectively correspond to one of the light shielding patterns BP disposed in the second pitch P2. In the present embodiment, the second pitch P2 may range from 1 to 5 times the sub-pixel width W1 (that is, W1≤P2≤5W1), based on the design of the first pitch P1 of the spacers PS. Specifically, the second pitch P2 may be N times the sub-pixel width W1, wherein N is a positive integer from 1 to 5, that is, the second pitch P2 may be an integer multiple of the sub-pixel width W1.

In some embodiments, as shown in FIG. 2 and FIG. 3, the first pitch P1 between two adjacent spacers PS may be 4 times the sub-pixel width W1, and the second pitch P2 between two adjacent light shielding patterns BP may be 2 times the sub-pixel width W1. In such condition, in a row of light shielding patterns BP, every two light shielding patterns BP may correspond to a spacer PS, that is, one of the two adjacent light shielding patterns BP may correspond to the spacer PS, and the other one of the two adjacent light shielding patterns BP may not correspond to the spacer PS. In addition, in some embodiments, as shown in FIG. 2, the light shielding patterns BP in different rows may be aligned with each other in the second direction D2, that is, the light shielding patterns BP may be arranged respectively along the first direction D1 and the second direction D2 in the top view of the display device DD1. In such condition, after the spacers PS are disposed corresponding to the light shielding patterns BP through the above-mentioned design, the offset distance of the spacers in adjacent two rows (that is, the first distance S1 or the second distance S2 mentioned above) may be the same as the second pitch P2 between two adjacent light shielding patterns BP and may be half of the first pitch P1. That is, the spacers PS may be symmetrically disposed. In some embodiments, as shown in FIG. 3, the light shielding patterns BP in adjacent two rows may be staggered in the second direction D2, that is, the light shielding patterns BP in a row are not overlapped with the light shielding patterns BP in another row adjacent to the row in the second direction D2. In such condition, a distance SS (or an offset distance) may be included between the light shielding patterns BP in two adjacent rows. The distance SS may be an integer multiple of the sub-pixel width W1 and may be less than the second pitch P2. For example, as shown in FIG. 3, the distance SS may be 1 times the sub-pixel width W1 (that is, SS=W1). In such condition, after the spacers PS are disposed corresponding to the light shielding patterns BP through the above-mentioned design, the offset distance (that is, the first distance S1 or the second distance S2 mentioned above) between the spacers PS in adjacent two rows may be 1 times the sub-pixel width W1. That is, the spacers PS may be asymmetrically disposed.

In some embodiments, as shown in FIG. 4 and FIG. 5, the first pitch P1 between two adjacent spacers PS may be 4 times the sub-pixel width W1, and the second pitch P2 between two adjacent light shielding patterns BP may be 1 times the sub-pixel width W1. In such condition, in a row of the light shielding patterns BP, every four light shielding patterns BP may correspond to a spacer PS. In some embodiments, as shown in FIG. 4, after the spacers PS are disposed corresponding to the light shielding patterns BP through the above-mentioned design, the offset distance between the spacers PS in adjacent two rows may be half of the first pitch P1 (that is, 2 times the sub-pixel width W1). That is, the spacers PS may be symmetrically disposed. In some embodiments, as shown in FIG. 5, after the spacers PS are disposed corresponding to the light shielding patterns BP through the above-mentioned design, the offset distance between the spacers PS in adjacent two rows may be 1 times the sub-pixel width W1. That is, the spacers PS may be asymmetrically disposed.

According to the present embodiment, in a top view of the display device DD1, the size (such as area, but not limited thereto) of the light shielding pattern BP corresponding to the spacer PS and the size of the light shielding pattern BP not corresponding to the spacer PS may be substantially the same, but not limited thereto. In some embodiments, the size of the light shielding pattern BP not corresponding to the spacer PS may be less than the size of the light shielding pattern BP corresponding to the spacer PS. In other words, the size of the light shielding pattern BP not corresponding to the spacer PS may not be greater than the size of the light shielding pattern BP corresponding to the spacer PS in the present embodiment.

It should be noted that although it is not shown in FIG. 2 to FIG. 5, the light shielding layer BM may include the grid structure corresponding to the scan lines SL and the data lines DL. In addition, the arrangement of the sub-pixel regions SPX shown in FIG. 2 to FIG. 5 may refer to the arrangement shown in FIG. 1 or may include other suitable arrangements. Moreover, the disposition positions of the light shielding patterns BP and the spacers PS shown in FIG. 2 to FIG. 5 are exemplary, and the present embodiment is not limited thereto. The light shielding patterns BP and the spacers PS may have any suitable disposition positions as long as the above conditions are met. For example, although it is not shown in the figure, the first pitch P1 between two adjacent spacers PS may be 6 times the sub-pixel width W1, and the second pitch P2 between two adjacent light shielding patterns BP may be 2 or 3 times the sub-pixel width W, but not limited thereto.

According to the present embodiment, through the design of the positions of the light shielding patterns BP mentioned above, the difference in aperture ratios of different sub-pixel regions SPX may be reduced. In addition, the influence of the disposition positions or manufacturing process of the spacers PS on the aperture ratios of the sub-pixel regions SPX may be reduced. Therefore, the display effect of the display device DD1 may be improved.

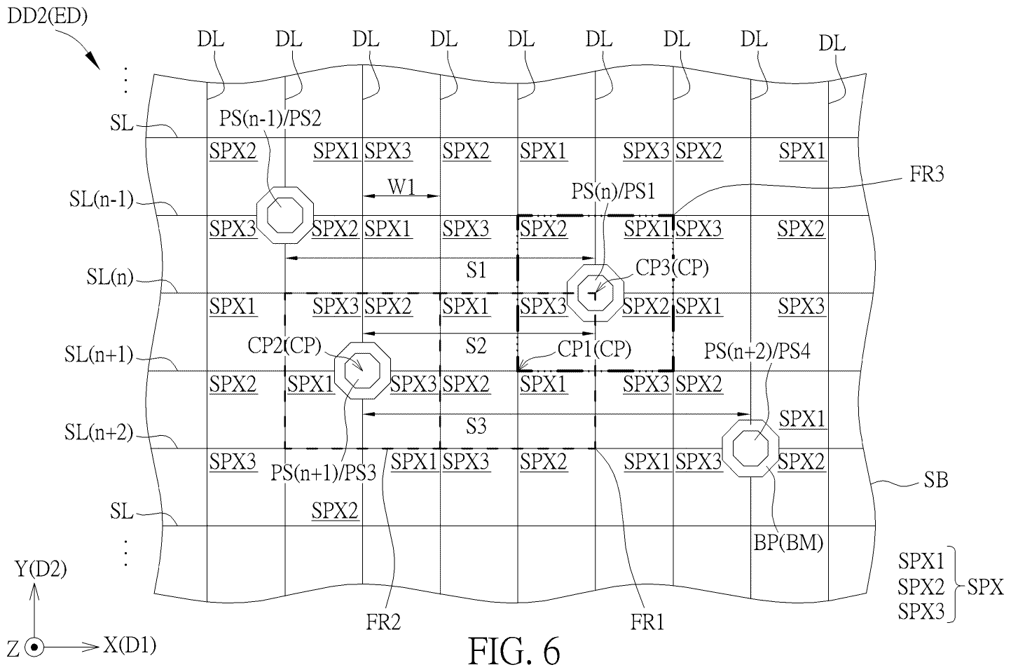

Referring to FIG. 6, FIG. 6 schematically illustrates a partial top view of a display device according to a third embodiment of the present disclosure. One of the main differences between the display device DD2 shown in FIG. 6 and the display device DD shown in FIG. 1 is the design of the positions of the spacers PS. Specifically, as shown in FIG. 6, the plurality of spacers PS of the display device DD2 of the present embodiment may be arranged in a plurality of rows in the second direction D2, and the spacers PS may include a first spacer PS1 located in the n^{th} row of the plurality of rows, a second spacer PS2 located in the n−1^{th} row of the plurality of rows and adjacent to the first spacer PS1, a third spacer PS3 located in the n+1^{th} row of the plurality of rows and adjacent to the first spacer PS1 and a fourth spacer PS4 located in the n+2^{th} row of the plurality of rows and adjacent to the third spacer PS3, wherein the first spacer PS1, the second spacer PS2, the third spacer PS3 are staggered in the second direction D2, and the first spacer PS1, the third spacer PS3 and the fourth spacer PS4 are staggered in the second direction D2. That is, the first spacer PS1, the second spacer PS2 and the third spacer PS3 do not correspond to each other in the second direction D2, and the first spacer PS1, the third spacer PS3 and the fourth spacer PS4 do not correspond to each other in the second direction D2. The definition of the feature “a spacer PS is adjacent to another spacer PS” may refer to the contents mentioned above, and will not be redundantly described. In other words, in the present embodiment, any three consecutive rows may be selected from the plurality of rows of spacers PS, and the first spacer PS1, the second spacer PS2 adjacent to the first spacer PS1 and the third spacer PS3 adjacent to the first spacer PS1 mentioned above are respectively defined in the three consecutive rows, wherein the first spacer PS1, the second spacer PS2 and the third spacer PS3 may be staggered. It should be noted that FIG. 6 just exemplarily shows one spacer PS in each of the rows, and the first spacer PS1, the second spacer PS2, the third spacer PS3 and the fourth spacer PS4 may respectively be one of the plurality of n^{th} row spacers PS(n), one of the plurality of n−1^{th} row spacers PS(n−1), one of the plurality of n+1^{th} row spacers PS(n+1) and one of the plurality of n+2^{th} row spacers PS(n+2). In the present embodiment, the plurality of spacers PS in a row may be repeatedly disposed corresponding to the crossing positions CP in the first pitch P1 mentioned above (it is not shown in FIG. 6, and the detail thereof may refer to the contents of the first embodiment above), and the range of the first pitch P1 may refer to the content of the first embodiment above.

In addition, in the present embodiment, a first distance S1 may be included between the first spacer PS1 and the second spacer PS2 in the first direction D1, a second distance S2 may be included between the first spacer PS1 and the third spacer PS3 in the first direction D1, and a third distance S3 may be included between the third spacer PS3 and the fourth spacer PS4 in the first direction D1. The first distance S1, the second distance S2 and the third distance S3 are integer multiple of the sub-pixel width W1. In the present embodiment, the first distance S1, the second distance S2 and the third distance S3 may respectively be greater than or equal to 10 micrometers (μm) (that is, 10 μm≤S1, S2, S3), but not limited thereto. The first distance S1 may be regarded as the offset distance between the n^{th} row spacers PS(n) and the n−1^{th} row spacers PS(n−1); the second distance S2 may be regarded as the offset distance between the n^{th} row spacers PS(n) and the n+1^{th} row spacers PS(n+1); and the third distance S3 may be regarded as the offset distance between the n+1^{th} row spacers PS(n+1) and the n+2^{th} row spacers PS(n+2). According to the present embodiment, the first distance S1, the second distance S2 and the third distance S3 may be different from each other (that is, S1≠S2≠S3). In other words, the offset distance between the nth row spacers PS(n) and the n−1^{th} row spacers PS(n−1), the offset distance between the n^{th} row spacers PS(n) and the n+1^{th} row spacers PS(n+1) and the offset distance between the n+1^{th} row spacers PS(n+1) and the n+2^{th} row spacers PS(n+2) may be different from each other. For example, as shown in FIG. 6, the first distance S1 may be 4 times the sub-pixel width W1, the second distance S2 may be 3 times the sub-pixel width W1, and the third distance S3 may be 5 times the sub-pixel width W1, but not limited thereto. The above-mentioned design may be applied to any row of the spacers PS, which is not limited to what is shown in FIG. 6.

In addition, in the present embodiment, although it is not shown in FIG. 6, the positions of the spacers PS may further include the design that at least one sub-pixel region SPX in which the spacer PS is disposed is existed in a horizontal direction (that is, the first direction D1), a vertical direction (that is, the second direction D2) and an inclined direction of each sub-pixel region SPX, but not limited thereto. The inclined direction described herein may for example be a direction having an included angle of 45 degrees with the first direction D1 and the second direction D2, but not limited thereto. “The spacer PS is disposed in a sub-pixel region SPX” mentioned above may include the condition that the spacer PS at least partially overlap the sub-pixel region SPX in the normal direction of the display device DD2. For example, in FIG. 6, a spacer PS may be regarded as being disposed in four sub-pixel regions SPX surrounding the spacer PS. Specifically, through the position design of the spacer PS of the present embodiment, a sub-pixel region SPX may be selected from the plurality of sub-pixel regions SPX in the display device DD2, and at least one sub-pixel region SPX overlapped with a portion of the spacer PS may be found in the horizontal direction, the vertical direction and the inclined direction of the sub-pixel region SPX.

In addition, in the present embodiment, the positions of the spacers PS may further include the design of making the spacers PS not disposed corresponding to specific crossing positions CP, but not limited thereto. Specifically, as shown in FIG. 6, the sub-pixel regions SPX of the present embodiment may have a sub-pixel rendering arrangement, and the detail thereof may refer to FIG. 1 and the contents above, which will not be redundantly described. In such condition, an area may be formed of the sub-pixel regions SPX surrounding a crossing position CP (for example, four sub-pixel regions SPX surrounding a crossing position CP, but not limited thereto), and the crossing position CP is located in the area. For example, as shown in FIG. 6, an area FRI may be formed of the four sub-pixel regions SPX surrounding the crossing position CP1, wherein the area FR1 includes two first sub-pixel regions SPX1, one second sub-pixel region SPX2 and one third sub-pixel region SPX3; an area FR2 may be formed of the four sub-pixel regions SPX surrounding the crossing position CP2, wherein the area FR2 includes one first sub-pixel region SPX1, one second sub-pixel region SPX2 and two third sub-pixel regions SPX3; and an area FR3 may be formed of the four sub-pixel regions SPX surrounding the crossing position CP3, wherein the area FR3 includes one first sub-pixel region SPX1, two second sub-pixel regions SPX2 and one third sub-pixel region SPX3. In other words, the compositions of the area FR1, the area FR2 and the area FR3 may be different from each other. The areas formed of the sub-pixel regions SPX surrounding other crossing positions CP may be one of the area FR1, the area FR2 and the area FR3 according to the composition of the area. That is, the sub-pixel regions SPX surrounding the crossing positions CP may form a plurality of areas FR1, a plurality of areas FR2 and a plurality of areas FR3. According to the present embodiment, the spacer PS may not be disposed corresponding to the crossing positions CP located in the area FR1 (for example, the crossing position CP1). For example, as shown in FIG. 6, the spacers PS may be disposed corresponding to the crossing position CP2 located in the area FR2 and the crossing position CP3 located in the area FR3, but not disposed corresponding to the crossing position CP1 located in the area FR1. That is, the spacer PS of the present embodiment may not be disposed corresponding to a crossing position CP where the first sub-pixel region SPX1 has the highest proportion among the plurality of sub-pixel regions SPX surrounding the crossing position CP. Since the area FR1 has the largest number of the first sub-pixel regions SPX1, the above-mentioned design may reduce the condition that the spacer PS is disposed in the first sub-pixel region SPX1. In some embodiments, the first sub-pixel region SPX1 may include a green sub-pixel region, and the second sub-pixel region SPX2 and the third sub-pixel region SPX3 may include a red sub-pixel region and a blue sub-pixel region respectively. Since the human eye is more sensitive to green light than red light and blue light, by reducing the condition that the spacer PS is disposed in the first sub-pixel region SPX1, the influence of the spacer PS on the aperture ratio of the first sub-pixel region SPX1 may be reduced, thereby improving the display effect of the display device DD2. In some embodiments, the spacer PS may not be disposed corresponding to the crossing position CP in the area FR2 (for example, the crossing position CP2), thereby reducing the condition that the spacer PS is disposed in the third sub-pixel region SPX3. In some embodiments, the spacer PS may not be disposed corresponding to the crossing position CP in the area FR3 (for example, the crossing position CP3), thereby reducing the condition that the spacer PS is disposed in the second sub-pixel region SPX2.

According to the present embodiment, through the above-mentioned position design of the spacers PS, the randomness of distribution of the spacers PS may increase to reduce the condition that the spacers PS are disposed only in specific sub-pixel regions SPX. Specifically, through the above-mentioned position design of the spacers PS, the condition that the difference between the number of spacers PS disposed in the first sub-pixel regions SPX1, the number of spacers PS disposed in the second sub-pixel regions SPX2 and the number of spacers PS disposed in the third sub-pixel regions SPX3 is excessive large may be reduced. “The spacer PS is disposed in a sub-pixel region SPX” described herein may include the condition that the spacer PS is at least partially overlapped with the sub-pixel region SPX in the normal direction of the display device DD2. For example, a spacer PS in FIG. 6 may be regarded as being disposed in the four sub-pixel regions SPX surrounding the spacer PS. Therefore, the difference in aperture ratios of different sub-pixel regions SPX may be reduced, thereby reducing the influence of the spacer PS on the display effect of the display device DD2. In addition, the position design of the spacers PS of the present embodiment may increase the average aperture ratio of the sub-pixel regions SPX, thereby improving the light emitting effect of the display device DD2.

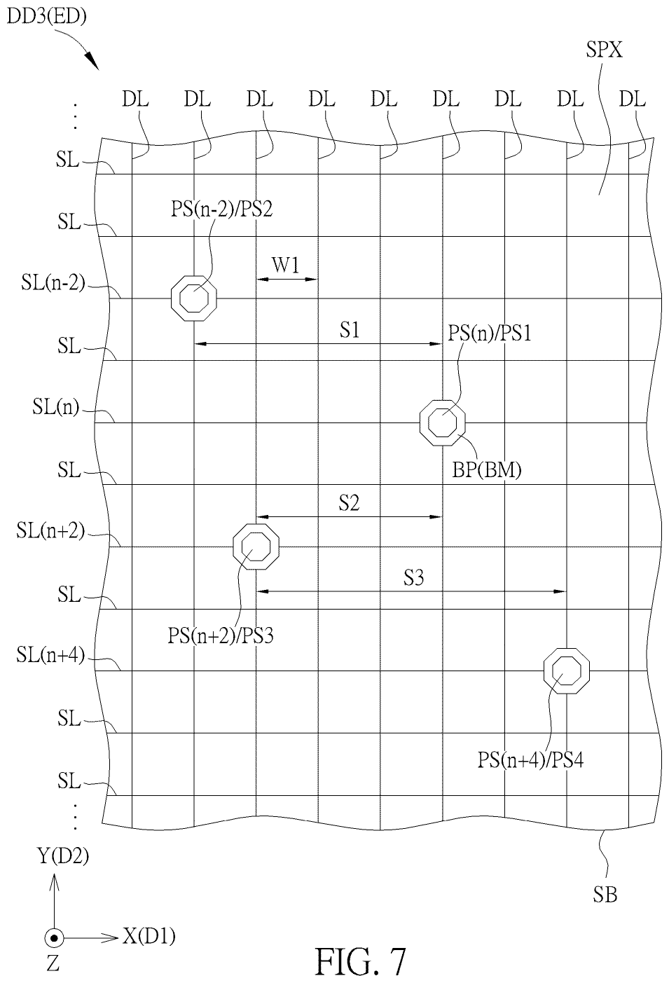

Referring to FIG. 7, FIG. 7 schematically illustrates a partial top view of a display device according to a fourth embodiment of the present disclosure. One of the main differences between the display device DD3 shown in FIG. 7 and the display device DD2 shown in FIG. 6 is the position design of the spacers PS. Specifically, the position design of the spacers PS in the present embodiment may be achieved by implementing the position design of the spacers PS shown in FIG. 6 in every two rows. For example, as shown in FIG. 7, the plurality of spacers PS of the display device DD3 may be arranged in a plurality of rows arranged in the second direction D2, and the plurality of spacers PS may include a first spacer PS1 located in the n^{th} row of the plurality of rows, a second spacer PS2 located in the n−2^{th} row of the plurality of rows and adjacent to the first spacer PS1, a third spacer PS3 located in the n+2^{th} row of the plurality of rows and adjacent to the first spacer PS1 and a fourth spacer PS4 located in the n+4^{th} row of the plurality of rows and adjacent to the third spacer PS3. Specifically, one of the spacers PS in the n−2^{th} row that is closest to the first spacer PS1 located in the n^{th} row may be defined as the second spacer PS2, and the third spacer PS3 and the fourth spacer PS4 may be defined through the same way, and will not be redundantly described. In the present embodiment, the first spacer PS1, the second spacer PS2 and the third spacer PS3 are staggered in the second direction D2, and the first spacer PS1, the third spacer PS3 and the fourth spacer PS4 are staggered in the second direction D2. In addition, a first distance S1 may be included between the first spacer PS1 and the second spacer PS2 in the first direction D1, a second distance S2 may be included between the first spacer PS1 and the third spacer PS3 in the first direction D1, and a third distance S3 may be included between the third spacer PS3 and the fourth spacer PS4 in the first direction D1, wherein the first distance S1, the second distance S2 and the third distance S3 may be different from each other (that is, S1≠S2≠S3). The features of the first distance S1, the second distance S2 and the third distance S3 may refer to the contents mentioned above, and will not be redundantly described. It should be noted that the above-mentioned design may be applied to any row of the spacers PS. In addition, although it is not shown in FIG. 7, each scan line SL may correspond to at least one spacer PS, and the disposition positions of the spacers PS may refer to the designs in the embodiments mentioned above.

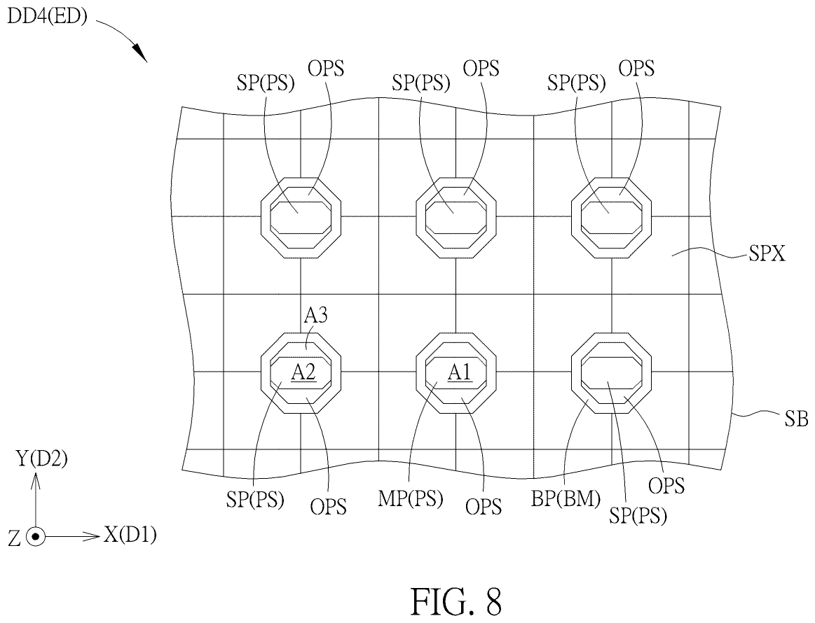

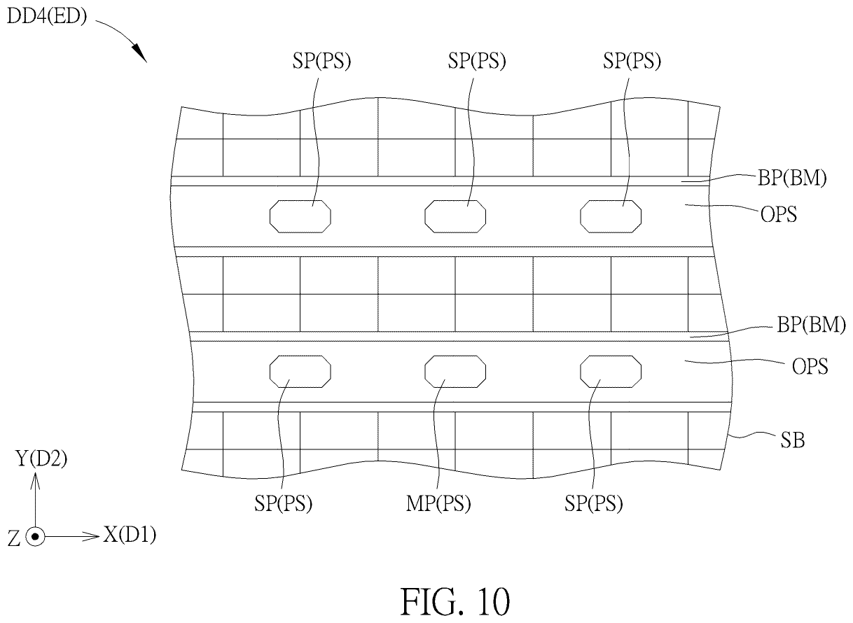

Referring to FIG. 8 to FIG. 10, FIG. 8 schematically illustrates a partial top view of a display device according to a fifth embodiment of the present disclosure, FIG. 9 schematically illustrates a partial cross-sectional view of the display device according to the fifth embodiment of the present disclosure, and FIG. 10 schematically illustrates a partial top view of a display device according to a variant embodiment of the fifth embodiment of the present disclosure. According to the present embodiment, as shown in FIG. 8, the spacers PS of the display device DD4 may include main spacers MP and sub spacers SP. The main spacer MP may be one of the spacers PS with a greater size, and the sub spacer SP may be one of the spacers PS with a smaller size, that is, the size of the main spacer MP is greater than the size of the sub spacer SP. “The size of the spacer PS” mentioned above may for example be the height (or the thickness) of the spacer PS, but not limited thereto. For example, as shown in FIG. 9, the spacers PS of the display device DD4 may include a main spacer MP and a sub spacer SP, wherein the main spacer MP has a height H1, the sub spacer SP has a height H2, and the height H1 is greater than the height H2. According to the present embodiment, in the normal direction of the display device DD4, the main spacer MP may have an area A1, and the sub spacer SP may have an area A2, wherein the area A1 may be the same as the area A2. In other words, in a top view of the display device DD4, the area of the pattern of the main spacer MP and the area of the pattern of the sub spacer SP may substantially be the same. The pattern of the main spacer MP and the pattern of the sub spacer SP may be the same, but not limited thereto. In some embodiments, the pattern of the main spacer MP and the pattern of the sub spacer SP may be different, but the area of the pattern of the main spacer MP and the area of the pattern of the sub spacer SP may be the same. Through the design mentioned above, the difference in size (such as area) between the light shielding pattern BP corresponding to the main spacer MP and the light shielding pattern BP corresponding to the sub spacer SP may be reduced, thereby reducing the difference in aperture ratios of the sub-pixel regions SPX.

In addition, as shown in FIG. 8 and FIG. 9, the display device DD4 of the present embodiment may further include opposite spacers OPS corresponding to the plurality of main spacers MP and the plurality of sub spacers SP. Specifically, as shown in FIG. 9, the display device DD4 may include a plurality of opposite spacers OPS disposed on the electrode EL3 and an opposite substrate OSB, wherein the plurality of spacers PS(including the main spacers MP and the sub spacers SP) may be disposed on the opposite substrate SB. In detail, the light shielding layer BM may be disposed on the opposite substrate OSB at first, wherein the light shielding layer BM may include light shielding patterns BP corresponding to the spacers PS. After that, the protecting layer OC may be disposed on the opposite substrate OSB, and the plurality of spacers PS may be disposed on the protecting layer OC. After that, the substrate SB and the opposite substrate OSB may be assembled, such that the plurality of opposite spacers OPS correspond to the plurality of spacers PS respectively. As shown in FIG. 9, the opposite spacer OPS may contact the main spacer MP to which it corresponds, and a gap may be included between the opposite spacer OPS and the sub spacer SP to which it corresponds, or the opposite spacer OPS may not contact the sub spacer SP to which it corresponds. The material of the opposite substrate OSB may refer to the material of the substrate SB mentioned above. In some embodiments, the material of the opposite spacer OPS may be the same as the material of the spacer PS. In some embodiments, the material of the opposite spacer OPS may be the same as the material of the insulating layer IN8. The protecting layer OC may include any suitable element or layer capable of providing protection to the display device DD4.

In such condition, a light shielding pattern BP may correspond to an opposite spacer OPS and a spacer PS (may be a main spacer MP or a sub spacer SP). According to the present embodiment, as shown in FIG. 8, in the normal direction of the display device DD4, the opposite spacer OPS may have an area A3 greater than an area (such as the area A1 and the area A2) of the spacer PS (the main spacer MP or the sub spacer SP) to which it corresponds, such that the pattern of the spacer PS may fall within the pattern of the opposite spacer OPS. In addition, in the normal direction of the display device DD4, the areas A3 of the opposite spacers OPS may be substantially the same. Moreover, in the normal direction of the display device DD4, the area of the light shielding pattern BP may be greater than the area A3 of the opposite spacer OPS to which it corresponds, such that the pattern of the opposite spacer OPS and the pattern of the spacer PS may fall within the pattern of the light shielding pattern BP. Since the areas A3 of the opposite spacers OPS in the present embodiment may be substantially the same, the areas of the light shielding patterns BP corresponding to the opposite spacers OPS may be substantially the same. Therefore, the size difference of different light shielding patterns BP may be reduced, thereby reducing the difference in aperture ratio of the sub-pixel regions SPX. In other words, the difference between the area of the light shielding pattern BP corresponding to the main spacer MP and the area of the light shielding pattern BP corresponding to the sub spacer SP may be reduced by disposing the opposite spacers OPS with a fixed area. For example, in some embodiments, the area A1 of the main spacer MP may be greater than the area A2 of the sub spacer SP, but a light shielding pattern BP disposed corresponding to the main spacer MP and another light shielding pattern BP disposed corresponding to the sub spacer SP may have similar areas due to the opposite spacers OPS with a fixed area.

In some embodiments, as shown in FIG. 8, each of the plurality of opposite spacers OPS may correspond to a spacer PS respectively. In such condition, the opposite spacer OPS may for example have an island shape. In some embodiments, as shown in FIG. 10, the opposite spacer OPS may for example have a bar shape. In such condition, an opposite spacer OPS may correspond to a plurality of spacers PS. In addition, the light shielding pattern BP corresponding to the opposite spacer OPS may also have the bar shape, that is, a light shielding pattern BP may correspond to a plurality of spacers PS. It should be noted that although it is not shown in the figure, the opposite spacer OPS may further include other suitable shapes, which is not limited to the contents mentioned above.

It should be noted that the structure shown in FIG. 9 is exemplary, and the present disclosure is not limited thereto. In some embodiments, the spacers PS(including the main spacers MP and the sub spacers SP) may be disposed on the electrode EL3 (that is, disposed on the substrate SB), and the opposite spacers OPS may be disposed on the opposite substrate OSB. In some embodiments, the display device DD4 may not include the opposite spacer OPS. In such condition, the main spacer MP may contact the electrode EL3 and the protecting layer OC.

It should be noted that the disposition way of the spacers PS shown in FIG. 8 and FIG. 10 is exemplary, and the present embodiment is not limited thereto. Specifically, the design of the disposition positions of the spacers PS in the embodiments mentioned above may be applied to the disposition positions of the main spacers MP and the sub spacers SP of the present embodiment. In other words, the spacers PS shown in FIG. 1 to FIG. 7 may be the main spacers MP or the sub spacers SP. The distribution of the main spacers MP and the sub spacers SP may be determined according to the design of the display device DD4. In the present embodiment, the main spacers MP and the sub spacers SP may be distributed in any suitable way, such that the density of the main spacers MP may range from 0.03% to 0.06%, and the density of the sub spacers SP may be greater than or equal to 2%. “The density of the spacers PS” mentioned above may be defined as the number of the spacers PS in an unit area.

In addition, in the present embodiment, each of the light shielding patterns BP adjacent to the main spacer MP may correspond to a sub spacer SP. In other words, the display device DD4 may not include the light shielding pattern BP adjacent to the main spacer MP and not corresponding to the sub spacer SP. “A light shielding pattern BP is adjacent to a main spacer MP” mentioned above may include the condition that there is no other light shielding pattern BP between the light shielding pattern BP and the main spacer MP. In such condition, the spacer PS disposed adjacent to the main spacer MP may be the sub spacer SP. For example, as shown in FIG. 1, the spacer PS disposed corresponding to the crossing position CP(n,m) may be the main spacer MP, and the six light shielding patterns BP adjacent to the main spacer MP (that is, the six light shielding patterns BP respectively corresponding to the crossing position CP(n−1,m−2), the crossing position CP (n−2,m), the crossing position CP(n−1,m+2), the crossing position CP (n+1,m+2), the crossing position CP(n+2,m) and the crossing position CP(n+1,m−2)) may respectively correspond to a sub spacer SP. That is, the six spacers PS adjacent to the main spacer MP are sub spacers SP. In such condition, the distances respectively between the main spacer MP and the sub spacers SP adjacent to the main spacer MP may be the same, but not limited thereto. Through the design mentioned above, the possibility of uneven thickness between the two substrates (that is, the substrate SB and the opposite substrate OSB) of the display device DD4 may be reduced.

The features mentioned in the present embodiment may be applied to the display devices in the embodiments mentioned above.

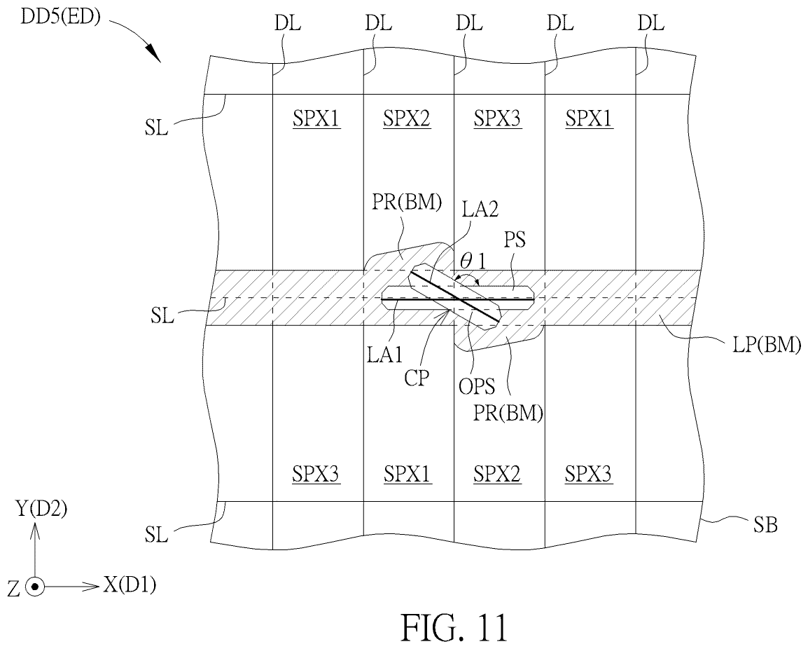

Referring to FIG. 11, FIG. 11 schematically illustrates a partial top view of a display device according to a sixth embodiment of the present disclosure. One of the main differences between the display device DD5 of the present embodiment and the display device DD4 shown in FIG. 8 is the design of the spacer PS and the opposite spacer OPS. The arrangement of the sub-pixel regions SPX of the present embodiment may refer to FIG. 1 and the contents mentioned above, which will not be redundantly described. According to the present embodiment, the display device DD5 may include the spacer PS and the opposite spacer OPS, wherein the opposite spacer OPS may be disposed corresponding to the spacer PS, but not limited thereto. As mentioned above, one of the spacer PS and the opposite spacer OPS may be disposed on the substrate SB, and another one of the spacer PS and the opposite spacer OPS may be disposed on the opposite substrate OSB, but not limited thereto. The spacer PS may overlap the four sub-pixel regions SPX surrounding the spacer PS, wherein the four sub-pixel regions SPX include two second sub-pixel regions SPX2, one first sub-pixel region SPX1 and one third sub-pixel region SPX3. According to the present embodiment, in a top view of the display device DD5, the opposite spacer OPS may extend in a direction not parallel to the first direction D1 and the second direction D2, such that the pattern of the opposite spacer OPS may not be parallel or perpendicular to the pattern of the spacer PS. For example, as shown in FIG. 11, the spacer PS and the opposite spacer OPS of the present embodiment may respectively have a bar shape in a top view of the display device DD5, and an included angle θ1 may be included between the bar shape of the spacer PS and the bar shape of the opposite spacer OPS, wherein the included angle θ1 is not 0 degree or not a right angle. The included angle θ1 may for example be an obtuse angle, but not limited thereto. Specifically, as shown in FIG. 11, through the design of the opposite spacer OPS mentioned above, in the four sub-pixel regions SPX surrounding the crossing position CP, the proportion of the opposite spacer OPS in the first sub-pixel region SPX1 may be less than the proportion of the opposite spacer OPS in the second sub-pixel region SPX2 or the third sub-pixel region SPX3. For example, as shown in FIG. 11, the opposite spacer OPS may be disposed in the way that the two ends of the opposite spacer OPS extend toward the two second sub-pixel regions SPX2 respectively, so as to reduce the portion of the opposite spacer OPS overlapped with the first sub-pixel region SPX1, but not limited thereto. In other words, in the present embodiment, the proportion of an opposite spacer OPS in the first sub-pixel region SPX1 surrounding the opposite spacer OPS may be reduced by changing the extending direction of the opposite spacer OPS. In such condition, the average aperture ratio of the first sub-pixel regions SPX1 may be greater than the average aperture ratio of the second sub-pixel regions SPX2 and the average aperture ratio of the third sub-pixel regions SPX3. According to the present embodiment, the first sub-pixel region SPX1 may be a green sub-pixel region, and the second sub-pixel region SPX2 and the third sub-pixel region SPX3 may include a red sub-pixel region and a blue sub-pixel region respectively. Since the human eye is more sensitive to green light than red light and blue light, by reducing the portion of the opposite spacer OPS overlapped with the green sub-pixel region, the aperture ratio of the green sub-pixel region may increase, thereby reducing the possibility of display abnormalities being observed by the human eye. It should be noted that the above-mentioned design is exemplary, and the present disclosure is not limited thereto. In some embodiments, the pattern or extending direction of the opposite spacer OPS may include any suitable design, such that the proportion of the opposite spacer OPS in the first sub-pixel region SPX1 is less than the proportion of the opposite spacer OPS in the second sub-pixel region SPX2 or the third sub-pixel region SPX3.

In addition, in the present embodiment, the light shielding layer BM may include linear portions LP and protruding portions PR protruded from the linear portions LP. The linear portions LP may correspond to the scan lines SL and the data lines DL. The protruding portions PR may be the portions of the light shielding layer BM protruding from two sides of the linear portion LP. The protruding portions PR may be disposed corresponding to the portions of the opposite spacer OPS protruding from the linear portion LP, such that the light shielding layer BM may overlap the opposite spacer OPS. Specifically, by making the light shielding layer BM include the protruding portions PR, in a top view of the display device DD5, the pattern of the opposite spacer OPS may fall within the pattern of the light shielding layer BM. According to the present embodiment, the protruding portions PR of the light shielding layer BM may be disposed not corresponding to the first sub-pixel region SPX1. For example, the protruding portions PR of the light shielding layer BM shown in FIG. 11 may be disposed corresponding to the second sub-pixel regions SPX2, but not limited thereto. Therefore, the influence of the light shielding layer BM on the aperture ratio of the first sub-pixel region SPX1 may be reduced. In some embodiments, an included angle θ1 may be included between a long axis LA1 of the spacer PS and a long axis LA2 of the opposite spacer OPS, wherein the included angle θ1 is not 0 degree or not a right angle. The included angle θ1 may for example be an obtuse angle, but not limited thereto. In some embodiments, the protruding portion PR may be disposed along the extending direction of the long axis LA2 of the opposite spacer OPS, and the protruding portion PR may not protrude from the linear portion LP or may be aligned with the linear portion LP, but not limited thereto.

It should be noted that although FIG. 11 shows only a group of the spacer PS and the opposite spacer OPS, the display device DD5 may include multiple groups of the spacers PS and the opposite spacers OPS, and the extending directions of the opposite spacers OPS in the groups may be respectively determined according to the composition of the sub-pixel regions SPX surrounding the crossing position to which the opposite spacers OPS correspond, such that the proportion of the opposite spacer OPS in the first sub-pixel region SPX1 is less than the proportion of the opposing spacer OPS in the second sub-pixel region SPX2 or the third sub-pixel region SPX3. In addition, the structure shown in FIG. 11 is exemplary, and the present disclosure is not limited thereto. In some embodiments, the spacer PS shown in FIG. 11 may be the opposite spacer OPS, and the opposite spacer OPS shown in FIG. 11 may be the spacer PS, that is, the features of the opposite spacer OPS mentioned above may be applied to the spacer PS. In some embodiments, the spacer PS and the opposite spacer OPS may not correspond to each other. For example, the spacer PS and the opposite spacer OPS may be disposed not corresponding to the same crossing position CP. In such condition, the opposite spacer OPS(or the spacer PS) may be disposed not corresponding to the first sub-pixel region(s) SPX1 among the plurality of sub-pixel regions SPX surrounding the opposite spacer OPS(or the spacer PS). The features described in the present embodiment may be applied to the display devices in the embodiments above.

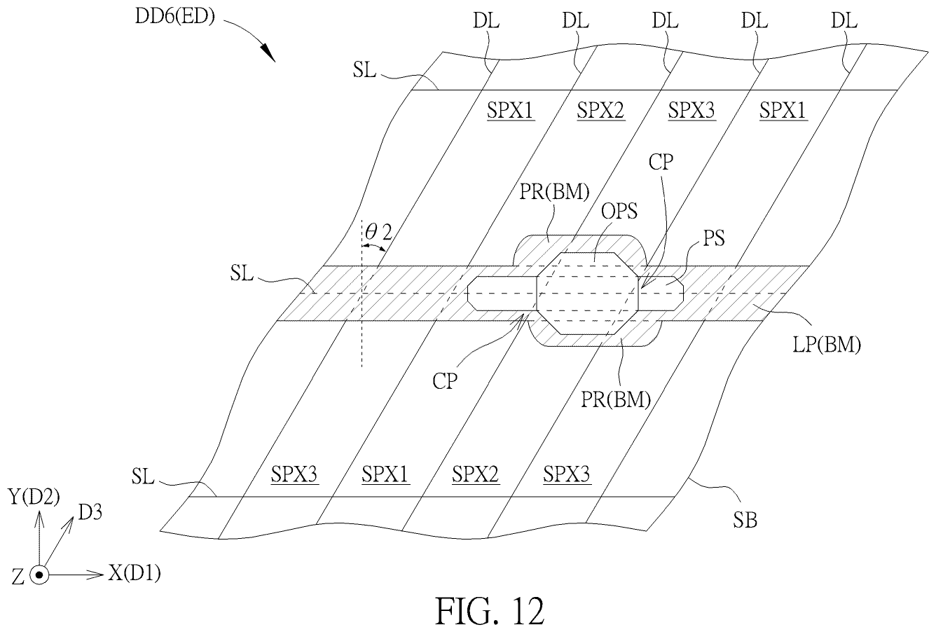

Referring to FIG. 12, FIG. 12 schematically illustrates a partial top view of a display device according to a seventh embodiment of the present disclosure. One of the main differences between the display device DD6 of the present embodiment and the display device DD4 shown in FIG. 8 is the design of the spacer PS and the opposite spacer OPS. The arrangement of the sub-pixel regions SPX of the present embodiment may refer to FIG. 1 and the contents mentioned above, and will not be redundantly described. In addition, in the present embodiment, an included angle θ2 may be included between the sub-pixel region SPX of the display device DD6 and the second direction D2, wherein the included angle θ2 may be greater than or equal to 10 degrees. In other words, the sub-pixel regions SPX are inclined. Specifically, in the present embodiment, the data lines DL may extend along a third direction D3, and the included angle θ2 may be included between the third direction D3 and the second direction D2. Therefore, the data lines DL extending along the third direction D3 and the scan lines SL extending along the first direction D1 may cross each other and form the plurality of inclined sub-pixel regions SPX. The feature of the inclined sub-pixel regions SPX of the present embodiment may be applied to the display device DD5 in the above-mentioned embodiment shown in FIG. 11.

The display device DD6 of the present embodiment may include the spacer PS and the opposite spacer OPS, wherein the opposite spacer OPS may be disposed corresponding to the spacer PS, but not limited thereto. According to the present embodiment, a spacer PS may be disposed corresponding to two crossing positions CP and may overlap six sub-pixel regions SPX surrounding the spacer PS. Specifically, as shown in FIG. 12, the spacer PS may be disposed corresponding to two crossing positions CP arranged in the first direction D1 and may overlap two first sub-pixel regions SPX1, two second sub-pixel regions SPX2 and two third sub-pixel regions SPX3 surrounding the spacer PS, but not limited thereto. In addition, in the present embodiment, the opposite spacer OPS disposed corresponding to the spacer PS may not correspond to the first sub-pixel regions SPX1 among the six sub-pixel regions SPX surrounding the spacer PS. For example, as shown in FIG. 12, the opposite spacer OPS may overlap the second sub-pixel regions SPX2 and the third sub-pixel regions SPX3 among the six sub-pixel regions SPX surrounding the spacer PS to which the opposite spacer OPS corresponds in the normal direction of the display device DD6, but the opposite spacer OPS does not correspond to the first sub-pixel regions SPX1 among the six sub-pixel regions SPX. In the present embodiment, as shown in FIG. 12, since the sub-pixel regions SPX are inclined, the opposite spacer OPS does not need to extend in a specific direction, and the opposite spacer OPS may overlap the second sub-pixel region SPX2 and the third sub-pixel region SPX3 located there above and the second sub-pixel region SPX2 and the third sub-pixel region SPX3 there below. Through the design mentioned above, the average aperture ratio of the first sub-pixel regions SPX1 is greater than the average aperture ratio of the second sub-pixel regions SPX2 and the average aperture ratio of the third sub-pixel regions SPX3. According to the present embodiment, the first sub-pixel region SPX1 may be a green sub-pixel region, and the second sub-pixel region SPX2 and the third sub-pixel region SPX3 may include a red sub-pixel region and a blue sub-pixel region respectively. Since the human eye is more sensitive to green light than red light and blue light, by reducing the portion of the opposite spacer OPS overlapped with the green sub-pixel region, the aperture ratio of the green sub-pixel region may increase, thereby reducing the possibility of display abnormalities being observed by the human eye. In some embodiments, the spacer PS may correspond to any number of crossing positions CP and may overlap the sub-pixel regions SPX surrounding the spacer PS, and the opposite spacer OPS disposed corresponding to the spacer PS may not overlap the first sub-pixel regions SPX1 among the sub-pixel regions SPX surrounding the spacer PS.

In addition, in the present embodiment, the light shielding layer BM may include the linear portions LP and the protruding portions PR protruding from the linear portions LP. The definitions of the linear portion LP and the protruding portion PR may refer to the embodiments mentioned above. The protruding portions PR may be disposed corresponding to the portions of the opposite spacer OPS protruding from the linear portion LP, such that the light shielding layer BM may overlap the opposite spacer OPS. According to the present embodiment, the protruding portion PR of the light shielding layer BM may be disposed not corresponding to the first sub-pixel region SPX1. For example, as shown in FIG. 12, the protruding portions PR of the light shielding layer BM may be disposed corresponding to the second sub-pixel regions SPX2 and the third sub-pixel regions SPX3, but not limited thereto. Therefore, the influence of the light shielding layer BM on the aperture ratio of the first sub-pixel region SPX1 may be reduced, thereby improving the display effect of the display device DD6.

It should be noted that although FIG. 12 shows only a group of the spacer PS and the opposite spacer OPS, the display device DD6 may include multiple groups of the spacers PS and the opposite spacers OPS. In addition, the structure shown in FIG. 12 is exemplary, and the present disclosure is not limited thereto. In some embodiments, the spacer PS shown in FIG. 12 may be the opposite spacer OPS, and the opposite spacer OPS shown in FIG. 12 may be the spacer PS, that is, the features of the opposite spacer OPS mentioned above may be applied to the spacer PS. Moreover, in some embodiments, the spacer PS and the opposite spacer OPS may not correspond to each other. For example, the spacer PS and the opposite spacer OPS may be disposed not corresponding to the same crossing position CP. In such condition, the opposite spacer OPS(or the spacer PS) may be disposed not corresponding to the first sub-pixel region(s) SPX1 among the plurality of sub-pixel regions SPX surrounding the opposite spacer OPS(or the spacer PS). The features described in the present embodiment may be applied to the display devices in the embodiments above.

In summary, a display device is provided by the present disclosure, wherein the display device includes a plurality of data lines, a plurality of scan lines, a plurality of sub-pixel regions formed by crossing the data lines and the scan lines, a plurality of spacers and a plurality of light shielding patterns corresponding to the spacers. Through the position designs of the spacers or the light shielding patterns or the structural design of the spacers mentioned above, the difference in aperture ratios of different sub-pixel regions may be reduced, thereby improving the display effect of the display device.

Those skilled in the art will readily observe that numerous modifications and alterations of the device and method may be made while retaining the teachings of the disclosure. Accordingly, the above disclosure should be construed as limited only by the metes and bounds of the appended claims.

What is claimed is:

1. A display device, comprising:
a substrate;
a plurality of scan lines disposed on the substrate and extending along a first direction respectively;
a plurality of data lines disposed on the substrate and extending along a second direction respectively, wherein the plurality of scan lines and the plurality of data lines cross each other at a plurality of crossing positions and form a plurality of sub-pixel regions, and one of the plurality of sub-pixel regions has a sub-pixel width; and
a plurality of spacers disposed on a portion of the plurality of crossing positions and arranged in a plurality of rows in the second direction, wherein the plurality of spacers comprise:
arranged along the first a plurality of n^{th} row spacers direction; and
a plurality of n+1^{th} row spacers arranged along the first direction;
wherein the plurality of n^{th} row spacers and the plurality of n+1^{th} row spacers are staggered in the second direction,
wherein a first pitch is included between adjacent two of the plurality of spacers in one of the plurality of rows in the first direction, and the first pitch is 2-12 times the sub-pixel width.

2. The display device of claim 1, wherein the plurality of spacers further comprises a plurality of n+2^{th} row spacers arranged along the first direction, the plurality of n^{th} row spacers comprise a first spacer, the plurality of n+1^{th} row spacers comprise a second spacer adjacent to the first spacer, the plurality of n+2^{th} row spacers comprise a third spacer adjacent to the second spacer, a first distance is included between the first spacer and the second spacer in the first direction, a second distance is included between the second spacer and the third spacer in the first direction, and the first distance is the same as the second distance.

3. The display device of claim 2, wherein the first distance is half of the first pitch.

4. The display device of claim 2, wherein the first distance is less than half of the first pitch.

5. The display device of claim 1, further comprising a light shielding layer disposed on the substrate, wherein the light shielding layer comprises a plurality of light shielding patterns, and in a normal direction of the display device, the plurality of light shielding patterns overlap the plurality of spacers respectively.

6. The display device of claim 5, wherein a second pitch is included between adjacent two of the plurality of light shielding patterns in the first direction, and the second pitch is the same as the first pitch.

7. The display device of claim 5, wherein a second pitch is included between adjacent two of the plurality of light shielding patterns in the first direction, and the second pitch is less than the first pitch.

8. The display device of claim 7, wherein the first pitch is an integer multiple of the second pitch.

9. The display device of claim 5, wherein the plurality of spacers comprises a main spacer and a sub spacer, a size of the main spacer is greater than a size of the sub spacer, the plurality of light shielding patterns comprises a first light shielding pattern corresponding to the main spacer and a second light shielding pattern corresponding to the sub spacer, and in a top view direction of the display device, a size of the first light shielding pattern is the same as a size of the second light shielding pattern.

10. The display device of claim 5, wherein the light shielding layer comprises a black matrix layer.

11. The display device of claim 1, further comprising a plurality of opposite spacers disposed on the substrate, wherein in a normal direction of the display device, the plurality of opposite spacers overlap the plurality of spacers respectively.

12. The display device of claim 11, wherein in the normal direction of the display device, an area of one of the plurality of opposite spacers is greater than an area of one of the plurality of spacers to which the one of the plurality of opposite spacers corresponds.

13. The display device of claim 11, wherein the plurality of spacers and the plurality of opposite spacers are linear in a top view of the display device, an included angle is included between one of the plurality of spacers and one of the plurality of opposite spacers to which the one of the plurality of spacers corresponds, and the included angle is an obtuse angle.

14. A display device, comprising:
a substrate;
a plurality of scan lines disposed on the substrate and extending along a first direction respectively;
a plurality of data lines disposed on the substrate and extending along a second direction respectively, wherein the plurality of scan lines and the plurality of data lines cross each other at a plurality of crossing positions; and
a plurality of spacers disposed on the plurality of crossing positions and arranged in a plurality of rows in the second direction, wherein the plurality of spacers comprise:
a first spacer located in a n^{th} row of the plurality of rows;
a second spacer adjacent to the first spacer and located in a n−1^{th} row of the plurality of rows, wherein a first distance is included between the first spacer and the second spacer in the first direction;
a third spacer adjacent to the first spacer and located in a n+1^{th} row of the plurality of rows, wherein a second distance is included between the first spacer and the third spacer in the first direction; and
a fourth spacer adjacent to the third spacer and located in a n+2^{th} row of the plurality of rows, wherein a third distance is included between the third spacer and the fourth spacer in the first direction,
wherein the first spacer, the second spacer and the third spacer are staggered in the second direction, the first spacer, the third spacer and the fourth spacer are staggered in the second direction, and the first distance, the second distance and the third distance are different from each other.

15. The display device of claim 14, wherein the first distance, the second distance and the third distance are greater than or equal to 10 micrometers respectively.

16. The display device of claim 14, further comprising a light shielding layer disposed on the substrate, wherein the light shielding layer comprises a plurality of light shielding patterns, and in a normal direction of the display device, the plurality of light shielding patterns overlap the plurality of spacers respectively.

17. The display device of claim 16, wherein the light shielding layer comprises a black matrix layer.

18. A display device, comprising:
a substrate;
a plurality of scan lines disposed on the substrate and extending along a first direction respectively;
a plurality of data lines disposed on the substrate and extending along a second direction respectively, wherein the plurality of scan lines and the plurality of data lines cross each other at a plurality of crossing positions; and
a plurality of spacers disposed on the plurality of crossing positions and arranged in a plurality of rows in the second direction, wherein the plurality of spacers comprise:
a first spacer located in a n^{th} row of the plurality of rows;
a second spacer adjacent to the first spacer and located in a n−2^{th} row of the plurality of rows, wherein a first distance is included between the first spacer and the second spacer in the first direction;
a third spacer adjacent to the first spacer and located in a n+2^{th} row of the plurality of rows, wherein a second distance is included between the first spacer and the third spacer in the first direction; and
a fourth spacer adjacent to the third spacer and located in a n+4^{th} row of the plurality of rows, wherein a third distance is included between the third spacer and the fourth spacer in the first direction,
wherein the first spacer, the second spacer and the third spacer are staggered in the second direction, the first spacer, the third spacer and the fourth spacer are staggered in the second direction, and the first distance, the second distance and the third distance are different from each other.

19. The display device of claim 18, wherein the first distance, the second distance and the third distance are greater than or equal to 10 micrometers respectively.

20. The display device of claim 18, further comprising a light shielding layer disposed on the substrate, wherein the light shielding layer comprises a plurality of light shielding patterns, and in a normal direction of the display device, the plurality of light shielding patterns overlap the plurality of spacers respectively.
